(19) United States
(12) Patent Application Publication
(10) Pub. No.: US 2026/0332542 A1
(43) Pub. Date: Oct. 22, 2026

(54) OPTICAL SHUFFLER FOR RAIL OPTIMIZED SCALE-OUT FABRICS

(71) Applicant: Dell Products L.P., Round Rock, TX (US)

(72) Inventors: Claudio DeSanti, Santa Cruz, CA (US); Joseph LaSalle White, San Jose, CA (US)

(21) Appl. No.: 19/185,974

(22) Filed: Apr. 22, 2025

(51) Int. Cl. H04L 49/112; H04L 12/46; H04L 49/111

(52) U.S. Cl. CPC H04L 49/112; H04L 12/46; H04L 49/111

(57) ABSTRACT

A rack includes: a first server, in which the first server includes a first NIC and a first PU, in which a set of ports belongs to a different plane of a set of DPPs, in which a network is structured as the set of DPPs to support a mode of the first NIC, in which each plane of the set of DPPs includes a set of leaf switches (LSs) and a set of spine switches (SSs); and a second server, in which the second server includes a second NIC and a second PU, in which a shuffler shuffles the set of links and a second set of links of the second NIC to obtain: a third set of links that belongs to a first plane of the set of DPPs, and a fourth set of links that belongs to a second plane of the set of DPPs.

### BACKGROUND

Devices are often capable of performing certain functionalities that other devices are not configured to perform or are not capable of performing. In such scenarios, it may be desirable to adapt one or more systems to enhance the functionalities of devices that cannot perform those functionalities.

### BRIEF DESCRIPTION OF DRAWINGS

Certain embodiments disclosed herein will be described with reference to the accompanying drawings. However, the accompanying drawings illustrate only certain aspects or implementations of one or more embodiments disclosed herein by way of example and are not meant to limit the scope of the claims.

FIG. 1.1 shows a diagram of a system in accordance with one or more embodiments disclosed herein.

FIG. 1.2 shows a diagram of a server in accordance with one or more embodiments disclosed herein.

FIG. 2.1 shows an example two-tier scale-out fabric/network in accordance with one or more embodiments disclosed herein.

FIG. 2.2 shows an example set of parallel fabrics in accordance with one or more embodiments disclosed herein.

FIGS. 2.3-2.4 show a shuffler (or a shuffler device) in accordance with one or more embodiments disclosed herein.

FIGS. 3.1-3.3 show an example use case in accordance with one or more embodiments disclosed herein.

FIGS. 4.1-4.2 show an example use case in accordance with one or more embodiments disclosed herein.

FIGS. 5.1-5.2 show an example use case in accordance with one or more embodiments disclosed herein.

FIGS. 6.1-6.2 show an example use case in accordance with one or more embodiments disclosed herein.

FIGS. 7.1-7.2 show an example use case in accordance with one or more embodiments disclosed herein.

FIG. 8 shows a diagram of a computing device in accordance with one or more embodiments disclosed herein.

### DETAILED DESCRIPTION

Specific embodiments disclosed herein will now be described in detail with reference to the accompanying figures. In the following detailed description of the embodiments disclosed herein, numerous specific details are set forth in order to provide a more thorough understanding of one or more embodiments disclosed herein. However, it will be apparent to one of ordinary skill in the art that the one or more embodiments disclosed herein may be practiced without these specific details. In other instances, well-known features have not been described in detail to avoid unnecessarily complicating the description.

In the following description of the figures, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items, and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure, and the number of elements of the second data structure, may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase “operatively connected” may refer to any direct connection (e.g., wired directly between two devices or components) or indirect connection (e.g., wired and/or wireless connections between any number of devices or components connecting the operatively connected devices). Thus, any path through which information may travel may be considered an operative connection.

In general, a super network interface card (NIC) (e.g., NVIDIA CX-8 super NIC) can operate in three modes/configurations: (i) the configuration where the super NIC is configured with a single port (e.g., a single InfiniBand port), which provides an extended data rate (XDR) of 800 gigabytes per second (GB/s) (that operates as four times 200 GB/s), (ii) the configuration where the super NIC is reconfigured to support two Ethernet ports (each supporting 400 gigabit Ethernet (GbE)), and (iii) the configuration where the super NIC is reconfigured to support eight Ethernet ports (each supporting 100 GbE). Further, a radix 512 network switch may enable a two-tier network/fabric supporting up to 128,000 end points (e.g., NICs, super NICs, processing units (e.g., central processing units (CPUs), graphics processing units (GPUs), data processing units (DPUs), neural processing units (NPUs), tensor processing units (TPUs), etc.), etc., in a related server/host).

Supporting more than 100,000 end points within a two-tier network architecture/topology may be attractive to users/customers, as this approach may require less cables/cabling, network switches (or network switch devices), and/or transceivers than a three-tier network topology and may make network management significantly easier (e.g., via less latency during a data transmission process). To leverage a high-radix network switch (e.g., a radix 512 network switch) along with eight Ethernet ports (each supporting 100 GbE) (i.e., the 8×100 GbE mode) of a super NIC, a corresponding scale-out network/fabric may need to be structured as a set of disjoint parallel fabrics (or a set of disjoint fabric planes) (similar to a storage area network (SAN) model used in storage networking).

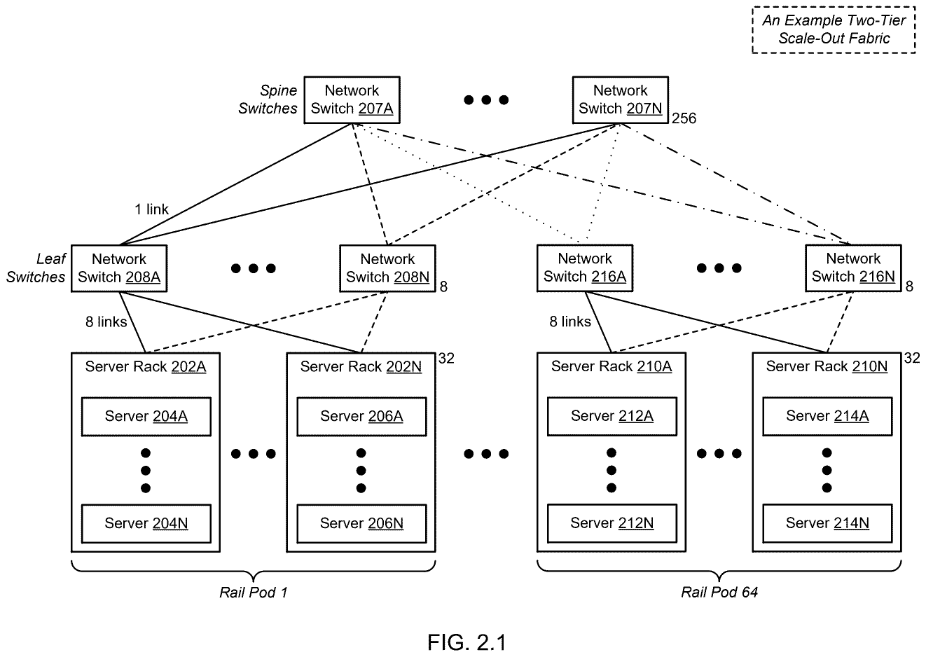

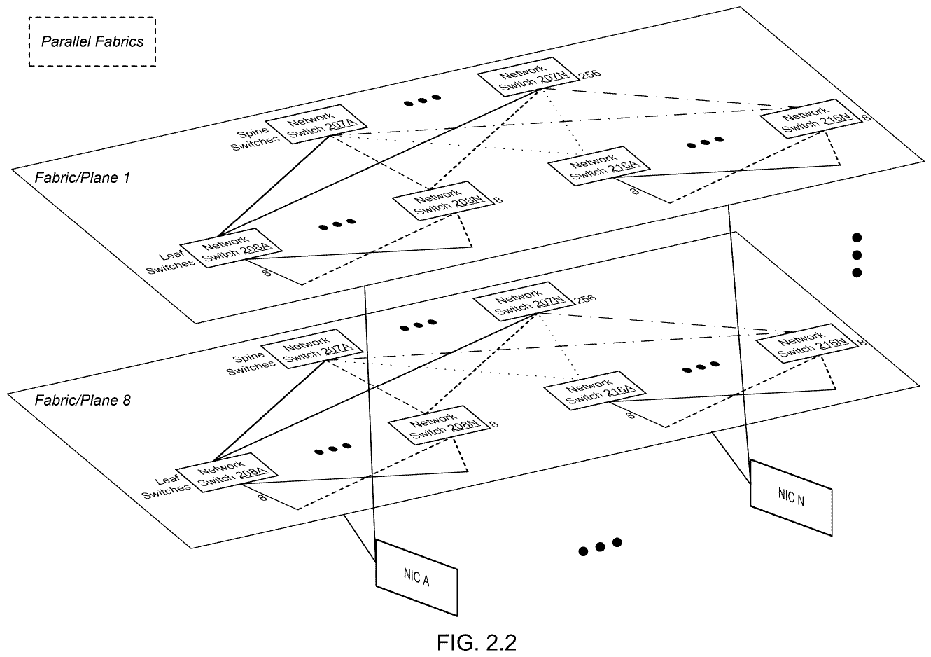

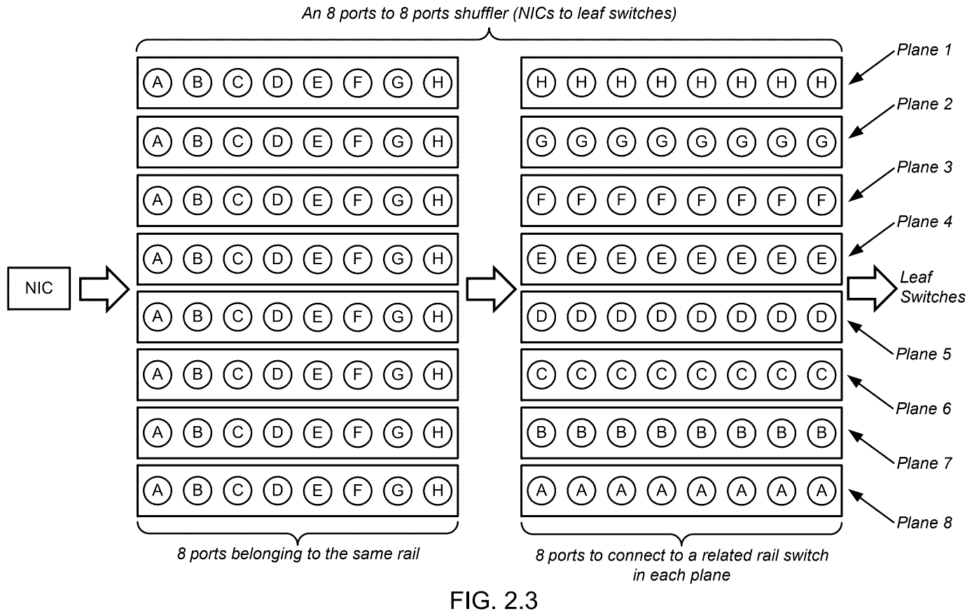

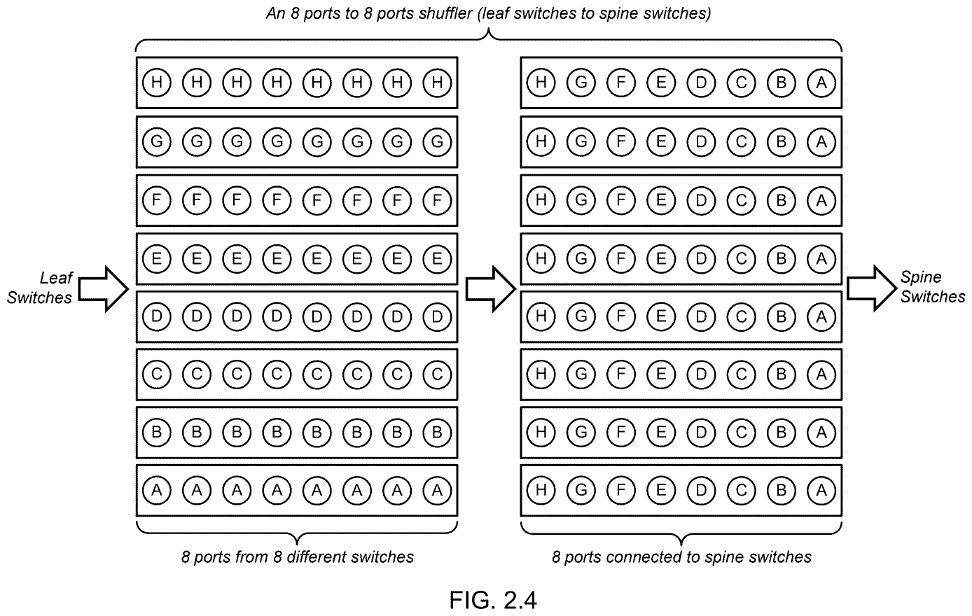

In addition, in order to support the aforementioned three modes (or operation modes), a super NIC may include/host an octal small form factor pluggable (OSFP) cage that hosts/uses OSFP modules/connectors. Separately, network switches that are used in a two-tier network topology may also use OSFP connectors. To achieve the “set of disjoint parallel fabrics” mode of operation: (i) eight 100 GbE links/lanes of each OSFP module (where eight 100 GbE ports are exposed as eight 100 GbE links) have to be extracted and connected to a different leaf network switch (or a leaf switch), which belongs to an appropriate plane (of the eight parallel fabric planes (see FIG. 2.2)), (ii) each leaf switch (or leaf switch port) connecting to an end point has to aggregate 100 GbE links of eight distinct super NICs, (iii) eight 100 GbE links of each leaf switch port connecting to spine network switches (or spine switches) have to be extracted and connected to a different spine switch (in the same fabric plane), and (iv) each spine switch (or spine switch port) connecting to leaf switches has to aggregate 100 GbE links of eight distinct leaf switches.

However, none of the current/traditional approaches (e.g., approaches to achieve the “set of disjoint parallel fabrics” mode of operation) does not enable scaling of a scale-out fabric (e.g., a rail optimized scale-out fabric) in an artificial intelligence (AI) cluster, as each super NIC hosts an OSFP module that is exposed to the fabric/network via two optical connectors (that needs to be connected to eight parallel fabrics).

For at least the reasons discussed above and without requiring resource-intensive efforts (e.g., time, engineering, etc.), a fundamentally different solution/framework is needed (e.g., a framework that enables scaling of a scale-out fabric (e.g., a rail optimized scale-out fabric), especially in an AI cluster).

Embodiments disclosed herein relate to systems/mechanisms to define an optical shuffler (or an optical shuffler device). As a result of the processes discussed below, one or more embodiments disclosed herein advantageously ensure that: (i) the shuffler enables achieving the “set of disjoint parallel fabrics” mode of operation in (or in conjunction with) a rail optimized scale-out fabric; (ii) the shuffler enables splitting fabric planes between corresponding NICs and leaf switches, by shuffling eight NIC ports that belong to the same network rail (in which a network rail is an independent subnetwork within the rail optimized network architecture that is generated by a related “rail” network switch) that get separated in eight ports to connect to a relevant network switch (or a rail switch, in this case) in each of the fabric planes; and/or (iii) the shuffler enables aggregating network rails between leaf switches and spine switches, by shuffling eight ports that belong to eight different network rails in a fabric plane to get eight ports to connect to spine switches in that particular fabric plane.

The following describes various embodiments disclosed herein.

While the following describes using caches (or storage) in DPUs, embodiments disclosed herein may be implemented using other caches that are operatively connected to the processing units (e.g., GPUs, NPUs, TPUs, CPUs, etc.) without departing from the scope of the embodiments disclosed herein. Further, while the following describes embodiments in the context of AI workloads, embodiments disclosed herein may be implemented for any other types of workloads without departing from the scope of the embodiments disclosed herein.

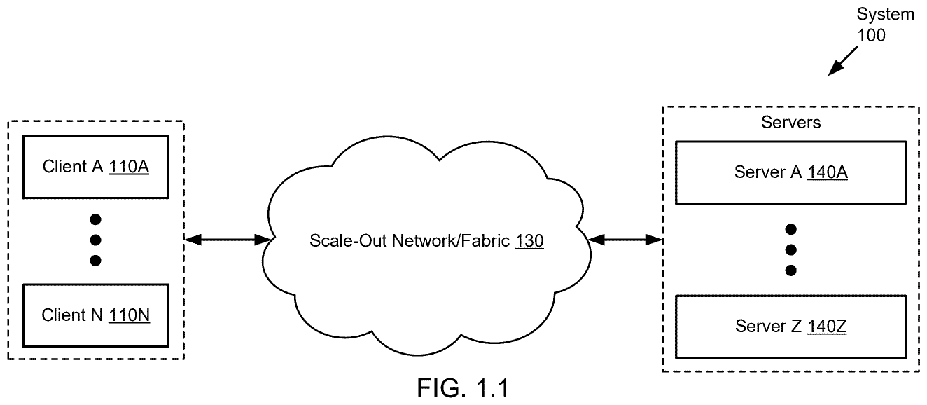

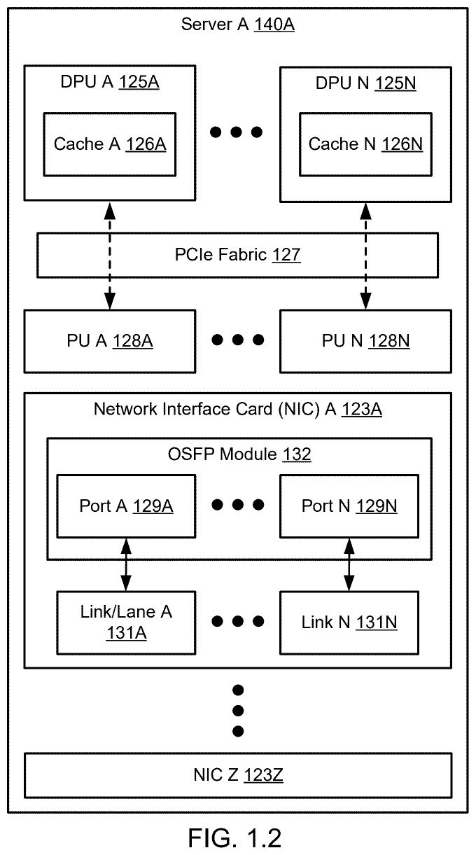

FIG. 1.1 shows a diagram of a system (100) in accordance with one or more embodiments disclosed herein. The system (100) includes any number of clients (e.g., Client A (110A), Client N (110N), etc.), any number of servers/nodes/hosts (e.g., Server A (140A), Server Z (140Z), etc.), and a scale-out network/fabric (130). The system (100) may include additional, fewer, and/or different components without departing from the scope of the embodiments disclosed herein. Each component may be operably/operatively connected to any of the other components via any combination of wired and/or wireless connections. Each component illustrated in FIG. 1.1 is discussed below.

In one or more embodiments, the clients (e.g., 110A, 110N, etc.), the servers (e.g., 140A, 140Z, etc.), and the scale-out network (130) may be (or may include) physical hardware or logical devices, as discussed below. While FIG. 1.1 shows a specific configuration of the system (100), other configurations may be used without departing from the scope of the embodiments disclosed herein. For example, although the clients (e.g., 110A, 110N, etc.) and the servers (e.g., 140A, 140Z, etc.) are shown to be operatively connected through a communication network (enabled by the scale-out network (130)), the clients (e.g., 110A, 110N, etc.) and the servers (e.g., 140A, 140Z, etc.) may be directly connected (e.g., without an intervening communication network).

Further, the functioning of the clients (e.g., 110A, 110N, etc.) and the servers (e.g., 140A, 140Z, etc.) is not dependent upon the functioning and/or existence of the other components (e.g., devices) in the system (100). Rather, the clients and the servers may function independently and perform operations locally that do not require communication with other components. Accordingly, embodiments disclosed herein should not be limited to the configuration of components shown in FIG. 1.1.

As used herein, “communication” may refer to simple data passing, or may refer to two or more components coordinating a job. As used herein, the term “data” is intended to be broad in scope. In this manner, that term embraces, for example (but not limited to): a data stream (or stream data), data chunks, data blocks, atomic data, emails, objects of any type, files of any type (e.g., media files, spreadsheet files, database files, etc.), contacts, directories, sub-directories, volumes, etc.

As used herein, a “volume” may be analogous to a logical unit number in a SAN, in which a volume may be a subset of a storage system's capacity presented by a storage node of the storage system as a local block device. A volume's data may be evenly distributed across all storage resources of the storage system, for example, according to a data layout selected for the storage system.

In one or more embodiments, although terms such as “document”, “file”, “segment”, “block”, or “object” may be used by way of example, the principles of the present disclosure are not limited to any particular form of representing and storing data or other information. Rather, such principles are equally applicable to any object capable of representing information.

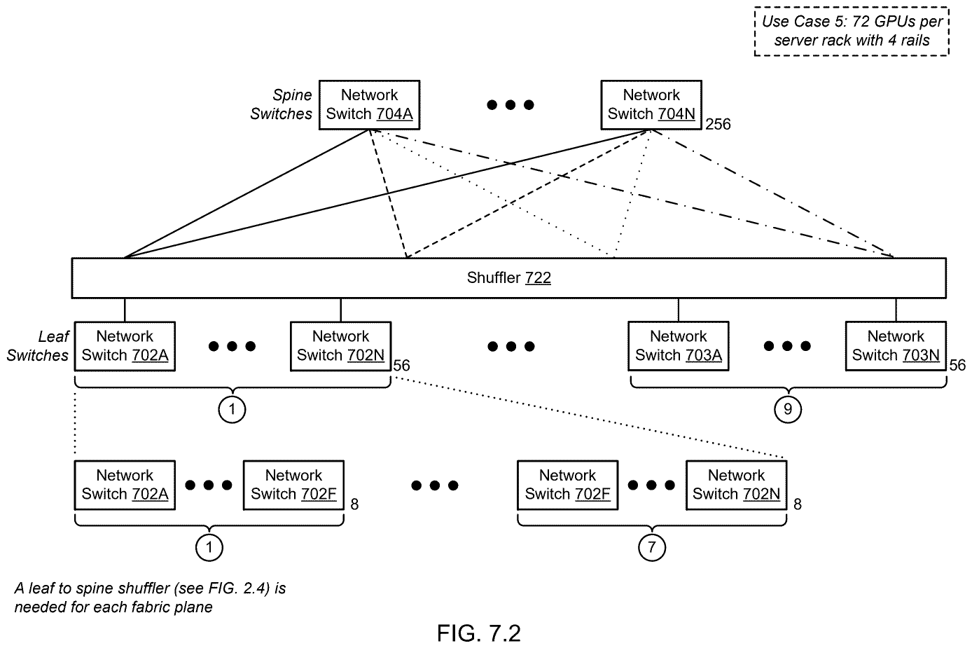

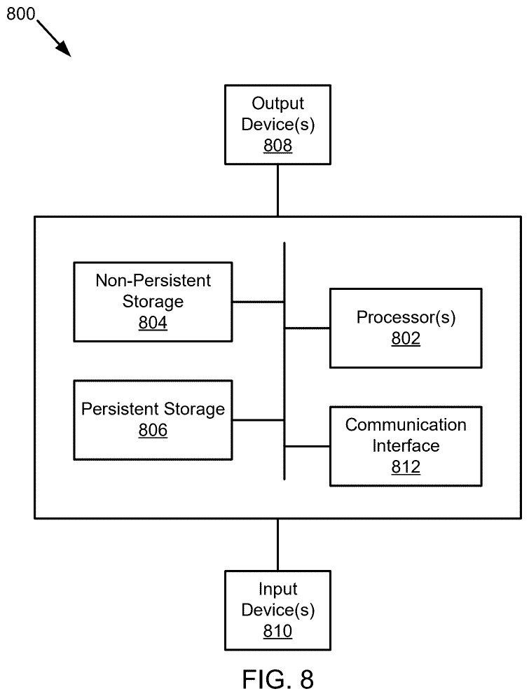

In one or more embodiments, the system (100) may be a distributed system (e.g., a data processing environment) and may deliver at least computing power (e.g., real-time (on the order of milliseconds (ms) or less) network monitoring, server virtualization, data deduplication, etc.), storage capacity (e.g., data backup), and data protection (e.g., software-defined data protection, disaster recovery, etc.) as a service to users (e.g., people, tenants, etc.) of clients (e.g., 110A, 110N, etc.). For example, the system (100) may be configured to organize unbounded, continuously generated data into a data stream. The system (100) may also represent a comprehensive middleware layer executing on computing devices (e.g., 800, FIG. 8) that supports application and storage environments.

In one or more embodiments, the system (100) may support one or more virtual machine (VM) environments, and may map capacity requirements (e.g., computational load, storage access, etc.) of VMs and supported applications to available resources (e.g., processing resources, storage resources, etc.) managed by the environments. Further, the system (100) may be configured for workload placement collaboration and computing resource (e.g., processing, storage/memory, virtualization, networking, etc.) exchange.

To provide computer-implemented services to the users, the system (100) may perform some computations (e.g., data collection, distributed processing of collected data, etc.) locally (e.g., at the users'site using the clients (e.g., 110A, 110N, etc.)) and other computations remotely (e.g., away from the users'site using the servers (e.g., 140A, 140Z, etc.)) from the users. By doing so, the users may utilize different computing devices (e.g., 800, FIG. 8) that have different quantities of computing resources (e.g., processing cycles, memory, storage, etc.) while still being afforded consistent user experience. For example, by performing some computations remotely, the system (100) (i) may maintain the consistent user experience provided by different computing devices even when the different computing devices possess different quantities of computing resources, and (ii) may process data more efficiently in a distributed manner by avoiding the overhead associated with data distribution and/or command and control via separate connections.

As used herein, “computing” refers to any operations that may be performed by a computer, including (but not limited to): computation, data storage, data retrieval, communications, etc. Further, as used herein, a “computing device” refers to any device in which a computing operation may be carried out. A computing device may be, for example (but not limited to): a compute component, a storage component, a network device, a telecommunications component, etc.

As used herein, a “resource” refers to any program, application, document, file, asset, executable program file, desktop environment, computing environment, or other resource made available to, for example, a user/customer of a client (described below). The resource may be delivered to the client via, for example (but not limited to): conventional installation, a method for streaming, a VM executing on a remote computing device, execution from a removable storage device connected to the client (such as universal serial bus (USB) device), etc.

In one or more embodiments, a client (e.g., 110A, 110N, etc.) may include functionality to, e.g.,: (i) capture sensory input (e.g., sensor data) in the form of text, audio, video, touch or motion, (ii) collect massive amounts of data at the edge of an Internet of Things (IoT) network (where, the collected data may be grouped as: (a) data that needs no further action and does not need to be stored, (b) data that should be retained for later analysis and/or record keeping, and (c) data that requires an immediate action/response), (iii) provide to other entities (e.g., Server A (140A)), store, or otherwise utilize captured sensor data (and/or any other type and/or quantity of data), (iv) provide surveillance services (e.g., determining object-level information, performing face recognition, etc.) for scenes (e.g., a physical region of space), (v) initiate AI model training and/or AI inferencing applications on one or more servers (e.g., 140A, 140Z, etc.), (vi) monitor the status of the AI model training and/or receive the results of AI inferencing applications, and/or (vii) permit users to interact with the scale-out network (130). One of ordinary skill will appreciate that the client may perform other functionalities without departing from the scope of the embodiments disclosed herein.

In one or more embodiments, the clients (e.g., 110A, 110N, etc.) may be geographically distributed devices (e.g., user devices, front-end devices, etc.) and may have relatively restricted hardware and/or software resources when compared to the servers (e.g., 140A, 140Z, etc.). As being, for example, a sensing device, each of the clients may be adapted to provide monitoring services. For example, a client may monitor the state of a scene (e.g., objects disposed in a scene). The monitoring may be performed by obtaining sensor data from sensors that are adapted to obtain information regarding the scene, in which a client may include and/or be operatively coupled to one or more sensors (e.g., a physical device adapted to obtain information regarding one or more scenes).

In one or more embodiments, the sensor data may be any quantity and types of measurements (e.g., of a scene's properties, of an environment's properties, etc.) over any period(s) of time and/or at any points-in-time (e.g., any type of information obtained from one or more sensors, in which different portions of the sensor data may be associated with different periods of time (when the corresponding portions of sensor data were obtained)). The sensor data may be obtained using one or more sensors. The sensor may be, for example (but not limited to): a visual sensor (e.g., a camera adapted to obtain optical information (e.g., a pattern of light scattered off of the scene) regarding a scene/environment), an audio sensor (e.g., a microphone adapted to obtain auditory information (e.g., a pattern of sound from the scene) regarding a scene), an electromagnetic radiation sensor (e.g., an infrared sensor), a chemical detection sensor, a temperature sensor, a humidity sensor, a count sensor, a distance sensor, a global positioning system sensor, a biological sensor, a differential pressure sensor, a corrosion sensor, etc.

In one or more embodiments, the clients (e.g., 110A, 110N, etc.) may be physical or logical computing devices configured for hosting one or more workloads, or for providing a computing environment whereon workloads may be implemented. The clients may provide computing environments that are configured for, at least: (i) workload placement collaboration, (ii) computing resource (e.g., processing, storage/memory, virtualization, networking, etc.) exchange, and (iii) protecting workloads (including their applications and application data) of any size and scale (based on, for example, one or more service level agreements (SLAs) configured by users of the clients). The clients (e.g., 110A, 110N, etc.) may correspond to computing devices that one or more users use to interact with one or more components of the system (100).

In one or more embodiments, a client (e.g., 110A, 110N, etc.) may represent a physical appliance or a computing device operated by one or more individuals of (or employed by) an organization. Examples of said individual(s) may include, but not limited to, any organization executive(s) (e.g., chief executive officer (CEO), chief financial officer (CFO), etc.), and any employee(s) in the accounting/finance team of the organization (e.g., a collector person). Further, the organization may refer to any enterprise at least engaged in for-profit commercial, industrial, or professional activities.

In one or more embodiments, a client (e.g., 110A, 110N, etc.) may include any number of applications (and/or content accessible through the applications) that provide computer-implemented services to a user. Applications may be designed and configured to perform one or more functions instantiated by a user of the client. In order to provide application services, each application may host similar or different components. The components may be, for example (but not limited to): instances of databases, instances of email servers, etc. Applications may be executed on one or more clients as instances of the application.

Applications may vary in different embodiments, but in certain embodiments, applications may be custom developed or commercial (e.g., off-the-shelf) applications that a user desires to execute in a client (e.g., 110A, 110N, etc.). In one or more embodiments, applications may be logical entities executed using computing resources of a client. For example, applications may be implemented as computer instructions stored on persistent storage of the client that when executed by the processor(s) of the client, cause the client to provide the functionality of the applications described throughout the application.

In one or more embodiments, while performing, for example, one or more operations requested by a user, applications installed on a client (e.g., 110A, 110N, etc.) may include functionality to request and use physical and logical resources of the client. Applications may also include functionality to use data stored in storage/memory resources of the client. The applications may perform other types of functionalities not listed above without departing from the scope of the embodiments disclosed herein. While providing application services to a user, applications may store data that may be relevant to the user in storage/memory resources of the client.

In one or more embodiments, to provide services to the users, the clients (e.g., 110A, 110N, etc.) may utilize, rely on, or otherwise cooperate with the servers (e.g., 140A, 140Z, etc.). For example, the clients may issue requests to Server A (140A) to receive responses and interact with various components of Server A (140A). The clients may also request data from and/or send data to Server A (140A) (for example, the clients may transmit information to Server A that allows Server A to perform computations, the results of which are used by the clients to provide services to the users). As yet another example, the clients may utilize computer-implemented services provided by Server Z (140Z). When the clients interact with Server Z (140Z), data that is relevant to the clients may be stored (temporarily or permanently) in Server Z.

In one or more embodiments, a client (e.g., 110A, 110N, etc.) may be capable of, e.g.,: (i) collecting users'inputs, (ii) correlating collected users'inputs to the computer-implemented services to be provided to the users, (iii) communicating with the servers (e.g., 140A, 140Z, etc.) that perform computations necessary to provide the computer-implemented services, (iv) using the computations performed by, for example, Server A (140A) to provide the computer-implemented services in a manner that appears (to the users) to be performed locally to the users, and/or (v) communicating with any virtual desktop (VD) in a virtual desktop infrastructure (VDI) environment (or a virtualized architecture) provided by the servers (using any known protocol in the art), for example, to exchange remote desktop traffic or any other regular protocol traffic (so that, once authenticated, users may remotely access independent VDs).

As described above, the clients (e.g., 110A, 110N, etc.) may provide computer-implemented services to users (and/or other computing devices). The clients may provide any number and any type of computer-implemented services. To provide computer-implemented services, each client may include a collection of physical components (e.g., processing resources, storage/memory resources, networking resources, etc.) configured to perform operations of the client and/or otherwise execute a collection of logical components (e.g., virtualization resources) of the client.

In one or more embodiments, a processing resource (not shown) may refer to a measurable quantity of a processing-relevant resource type, which can be requested, allocated, and consumed. A processing-relevant resource type may encompass a physical device (i.e., hardware), a logical intelligence (i.e., software), or a combination thereof, which may provide processing or computing functionality and/or services. Examples of a processing-relevant resource type may include (but not limited to): a CPU, a GPU, a DPU, a computation acceleration resource, an application-specific integrated circuit (ASIC), a digital signal processor for facilitating high speed communication, etc.

In one or more embodiments, a storage or memory resource (not shown) may refer to a measurable quantity of a storage/memory-relevant resource type, which can be requested, allocated, and consumed (for example, to store sensor data and provide previously stored data). A storage/memory-relevant resource type may encompass a physical device, a logical intelligence, or a combination thereof, which may provide temporary or permanent data storage functionality and/or services. Examples of a storage/memory-relevant resource type may be (but not limited to): a hard disk drive (HDD), a solid-state drive (SSD), random access memory (RAM), Flash memory, a tape drive, a fibre-channel (FC) based storage device, a floppy disk, a diskette, a compact disc (CD), a digital versatile disc (DVD), a non-volatile memory express (NVMe) device, a NVMe over Fabrics (NVMe-oF) device, resistive RAM (ReRAM), persistent memory (PMEM), virtualized storage, virtualized memory, etc.

In one or more embodiments, while the clients (e.g., 110A, 110N, etc.) provide computer-implemented services to users, the clients may store data that may be relevant to the users to the storage/memory resources. When the user-relevant data is stored (temporarily or permanently), the user-relevant data may be subjected to loss, inaccessibility, or other undesirable characteristics based on the operation of the storage/memory resources.

To mitigate, limit, and/or prevent such undesirable characteristics, users of the clients (e.g., 110A, 110N, etc.) may enter into agreements (e.g., SLAs) with providers (e.g., vendors) of the storage/memory resources. These agreements may limit the potential exposure of user-relevant data to undesirable characteristics. These agreements may, for example, require duplication of the user-relevant data to other locations so that if the storage/memory resources fail, another copy (or other data structure usable to recover the data on the storage/memory resources) of the user-relevant data may be obtained. These agreements may specify other types of activities to be performed with respect to the storage/memory resources without departing from the scope of the embodiments disclosed herein.

In one or more embodiments, a networking resource (not shown) may refer to a measurable quantity of a networking-relevant resource type, which can be requested, allocated, and consumed. A networking-relevant resource type may encompass a physical device, a logical intelligence, or a combination thereof, which may provide network connectivity functionality and/or services. Examples of a networking-relevant resource type may include (but not limited to): a NIC, a network adapter, a network processor, etc.

In one or more embodiments, a networking resource may provide capabilities to interface a client with external entities (e.g., Server A (140A)) and to allow for the transmission and receipt of data with those entities. A networking resource may communicate via any suitable form of wired interface (e.g., Ethernet, fiber optic, serial communication etc.) and/or wireless interface, and may utilize one or more protocols (e.g., transport control protocol (TCP), user datagram protocol (UDP), RDMA, RDMA over Converged Ethernet (RoCE), IEEE 801.11, etc.) for the transmission and receipt of data.

In one or more embodiments, a networking resource may implement and/or support the above-mentioned protocols to enable the communication between the client and the external entities. For example, a networking resource may enable the client to be operatively connected, via Ethernet, using a TCP protocol to form a “network fabric”, and may enable the communication of data between the client and the external entities. In one or more embodiments, each client may be given a unique identifier (e.g., an Internet Protocol (IP) address) to be used when utilizing the above-mentioned protocols.

Further, a networking resource, when using a certain protocol or a variant thereof, may support streamlined access to storage/memory media of other clients (e.g., 110A, 110N, etc.). For example, when utilizing Remote DMA (“RDMA”), e.g., RoCE to access data on another client, it may not be necessary to interact with the logical components of that client. Rather, when using RDMA, it may be possible for the networking resource to interact with the physical components of that client to retrieve and/or transmit data, thereby avoiding any higher-level processing by the logical components executing on that client.

In one or more embodiments, a virtualization resource (not shown) may refer to a measurable quantity of a virtualization-relevant resource type (e.g., a virtual hardware component), which can be requested, allocated, and consumed, as a replacement for a physical hardware component. A virtualization-relevant resource type may encompass a physical device, a logical intelligence, or a combination thereof, which may provide computing abstraction functionality and/or services. Examples of a virtualization-relevant resource type may include (but not limited to): a virtual server, a VM, a container, a virtual CPU (vCPU), a virtual storage pool, etc.

In one or more embodiments, a virtualization resource may include a hypervisor (e.g., a VM monitor), in which the hypervisor may be configured to orchestrate an operation of, for example, a VM by allocating computing resources of a client (e.g., 110A, 110N, etc.) to the VM. In one or more embodiments, the hypervisor may be a physical device including circuitry. The physical device may be, for example (but not limited to): a field-programmable gate array (FPGA), an application-specific integrated circuit, a programmable processor, a microcontroller, a digital signal processor, etc. The physical device may be adapted to provide the functionality of the hypervisor. Alternatively, in one or more of embodiments, the hypervisor may be implemented as computer instructions stored on storage/memory resources of the client that when executed by processing resources of the client, cause the client to provide the functionality of the hypervisor.

In one or more embodiments, a client (e.g., 110A, 110N, etc.) may be, for example (but not limited to): a physical computing device, a smartphone, a tablet, a wearable, a gadget, a closed-circuit television (CCTV) camera, a music player, a game controller, etc. Different clients may have different computational capabilities. In one or more embodiments, Client A (110A) may have 16 GB of dynamic RAM (DRAM) and 1 CPU with 12 cores, whereas Client N (110N) may have 8 GB of PMEM and 1 CPU with 16 cores. Other different computational capabilities of the clients not listed above may also be considered without departing from the scope of the embodiments disclosed herein.

Further, in one or more embodiments, a client (e.g., 110A, 110N, etc.) may be implemented as a computing device (e.g., 800, FIG. 8). The computing device may be, for example, a desktop computer, a server, a distributed computing system, or a cloud resource. The computing device may include one or more processors, memory (e.g., RAM), GPUs, NPUs, TPUs, and persistent storage (e.g., HDDs, SSDs, etc.). The computing device may include instructions, stored in the persistent storage, that when executed by the processor(s) of the computing device cause the computing device to perform the functionality of the client described throughout the application.

Alternatively, in one or more embodiments, the client (e.g., 110A, 110N, etc.) may be implemented as a logical device (e.g., a VM). The logical device may utilize the computing resources of any number of computing devices to provide the functionality of the client described throughout this application.

In one or more embodiments, users (e.g., administrators, organization executives, etc.) may interact with (or operate) the clients (e.g., 110A, 110N, etc.) in order to perform work-related tasks (e.g., production workloads). In one or more embodiments, the accessibility of users to the clients may depend on a regulation set by an administrator of the clients. To this end, each user may have a personalized user account that may, for example, grant access to certain data, applications, and computing resources of the clients. This may be realized by implementing virtualization technology. In one or more embodiments, an administrator may be a user with permission (e.g., a user that has root-level access) to make changes to the clients that will affect other users of the clients.

In one or more embodiments, for example, a user may be automatically directed to a login screen of a client when the user connected to that client. Once the login screen of the client is displayed, the user may enter credentials (e.g., username, password, etc.) of the user on the login screen. The login screen may be a graphical user interface (GUI) generated by a visualization module (not shown) of the client. In one or more embodiments, the visualization module may be implemented in hardware (e.g., circuitry), software, or any combination thereof.

In one or more embodiments, a GUI may be displayed on a display of a computing device (e.g., 800, FIG. 8) using functionalities of a display engine (not shown), in which the display engine is operatively connected to the computing device. The display engine may be implemented using hardware (or a hardware component), software (or a software component), or any combination thereof. The login screen may be displayed in any visual format that would allow the user to easily comprehend (e.g., read and parse) the listed information.

In one or more embodiments, a server (e.g., an information handling system) of the servers (e.g., 140A, 140Z, etc.) may include functionality to, e.g.,: (i) obtain (or receive) data (e.g., any type and/or quantity of input) from any source (and, if necessary, aggregate the data); (ii) process/analyze data that is received from one or more clients (e.g., 110A, 110N, etc.) to generate additional data that is derived from the obtained data without experiencing any middleware and hardware limitations; (iii) provide meaningful information (e.g., a response) back to the corresponding clients; (iv) filter data (e.g., received from a client) before pushing the data (and/or the derived data) to the storage for management of the data and/or for storage of the data (while pushing the data, the server may include information regarding a source of the data (e.g., an identifier of the source) so that such information may be used to associate provided data with one or more of the users (or data owners)); (v) host and maintain various workloads; (vi) provide a computing environment whereon workloads may be implemented (e.g., employing linear, non-linear, and/or AI models to perform cloud-based data processing); (vii) incorporate strategies (e.g., strategies to provide VDI capabilities) for remotely enhancing capabilities of the clients; (viii) provide robust security features to the clients and make sure that a minimum level of service is always provided to a user of a client; (ix) transmit the result(s) of the computing work performed (e.g., real-time business insights, equipment maintenance predictions, other actionable responses, etc.) to another server for review and/or other human interactions; (x) exchange data with other devices registered in/to the scale-out network/fabric (130) in order to, for example, participate in a collaborative workload placement (e.g., the node may split up a request (e.g., an operation, a task, an activity, etc.) with another server, coordinating its efforts to complete the request more efficiently than if the server had been responsible for completing the request); (xi) provide software-defined data protection for the clients (e.g., 110A, 110N, etc.); (xii) provide automated data discovery, protection, management, and recovery operations for the clients; (xiii) monitor operational states of the clients; (xiv) regularly back up configuration information of the clients to a storage system (not shown); (xv) provide (e.g., via a broadcast, multicast, or unicast mechanism) information (e.g., a location identifier, the amount of available resources, etc.) associated with the server to other servers of the system (100); (xvi) configure or control any mechanism that defines when, how, and what data to provide to the clients and/or to the storage system; (xvii) provide data deduplication to the clients (in conjunction with the storage system); (xviii) orchestrate data protection through one or more GUIs; (xix) empower data owners (e.g., users of the clients) to perform self-service data backup and restore operations from their native applications; (xx) ensure compliance and satisfy different types of service level objectives (SLOs) set by an administrator/user; (xxi) increase resiliency of an organization by enabling rapid recovery or cloud disaster recovery from cyber incidents; (xxii) provide operational simplicity, agility, and flexibility for physical, virtual, and cloud-native environments; (xxiii) consolidate multiple data process or protection requests (received from, for example, clients) so that duplicative operations (which may not be useful for restoration purposes) are not generated; (xxiv) initiate multiple data process or protection operations in parallel (e.g., a server may host multiple operations, in which each of the multiple operations may (a) manage the initiation of a respective operation and (b) operate concurrently to initiate multiple operations); and/or (xxv) manage operations of one or more clients (e.g., receiving information from the clients regarding changes in the operation of the clients) to improve their operations (e.g., improve the quality of data being generated, decrease the computing resources cost of generating data, etc.). In one or more embodiments, in order to read, write, or store data, the server (e.g., 140A, 140Z, etc.) may communicate with, for example, any storage device in the system (100).

In one or more embodiments, because technology and information handling needs vary between different users or applications, servers (e.g., 140A, 140Z, etc.) may also vary regarding what information/data is handled, how the information is handled, how much information is processed, stored, or communicated, and how quickly and efficiently the information may be processed, stored, or communicated. The variations in servers may allow for the servers to be general or configured for a specific user or specific use such as financial transaction processing, airline reservations, enterprise data storage, or global communications. In addition, servers (e.g., 140A, 140Z, etc.) may include a variety of hardware and software components that may be configured to process, store, and communicate information and may include one or more computer systems, data storage systems, and networking systems.

Further, a server of the servers (e.g., 140A, 140Z, etc.) may include functionality to execute one or more AI workloads (e.g., AI (or AI model) training workloads, AI inferencing workloads, etc.). Each server may include a local AI application (not shown) that manages the execution of various AI workloads on, for example, processing units (e.g., GPUs, NPUs, TPUs, CPUs, etc.) and/or DPUs of that server (see FIG. 1.2). In one or more embodiments, the servers (e.g., 140A, 140Z, etc.) may be operatively connected to each other via the scale-out network (130) when the servers are in different server racks and/or in different geographic locations/zones across the world.

As described above, a server (e.g., 140A, 140Z, etc.) may be capable of providing a range of functionalities/services to the users of the clients (e.g., 110A, 110N, etc.). However, not all users may be allowed to receive all the services. To manage the services provided to the users of the clients, a service manager (not shown) in accordance with embodiments disclosed herein may manage the operation of the scale-out network (130). in which the clients are operably connected to the servers over the scale-out network. Specifically, the service manager (i) may identify services to be provided by the servers (for example, based on the number of users using the clients) and (ii) may limit communications of the clients to receive server provided services.

For example, the priority (e.g., the user access level) of a user may be used to determine how to manage computing resources of Server A (140A) to provide services to that user. As yet another example, the priority of a user may be used to identify the services that need to be provided to that user. As yet another example, the priority of a user may be used to determine how quickly communications (for the purposes of providing services in cooperation with the internal network (and its subcomponents)) are to be processed by the internal network.

Further, consider a scenario where a first user is to be treated as a normal user (e.g. a non-privileged user, a user with a user access level/tier of 4/10). In such a scenario, the user level of that user may indicate that certain ports (of the subcomponents of the network corresponding to communication protocols such as the TCP, the UDP, etc.) are to be opened, other ports are to be blocked/disabled so that (i) certain services are to be provided to the user by Server Z (140Z) (e.g., while the computing resources of Server Z may be capable of providing/performing any number of remote computer-implemented services, they may be limited in providing some of the services over the network enabled/provided by the scale-out network (130)) and (ii) network traffic from that user is to be afforded a normal level of quality (e.g., a normal processing rate with a limited communication bandwidth (BW)). By doing so, (i) computer-implemented services provided to the users of the clients (e.g., 110A, 110N, etc.) may be granularly configured without modifying the operation(s) of the clients and (ii) the overhead for managing the services of the clients may be reduced by not requiring modification of the operation(s) of the clients directly.

In contrast, a second user may be determined to be a high priority user (e.g., a privileged user, a user with a user access level of 9/10). In such a case, the user level of that user may indicate that more ports are to be opened than were for the first user so that (i) Server A (140A) may provide more services to the second user and (ii) network traffic from that user is to be afforded a high-level of quality (e.g., a higher processing rate than the traffic from the normal user).

As used herein, a “workload” is a physical or logical component configured to perform certain work functions. Workloads may be instantiated and operated while consuming computing resources allocated thereto. A user may configure a data protection policy for various workload types. Examples of a workload may include (but not limited to): an AI workload, a data protection workload, a VM, a container, a network-attached storage (NAS), a database, an application, a collection of microservices, a file system (FS), small workloads with lower priority workloads (e.g., FS host data, operating system (OS) data, etc.), medium workloads with higher priority (e.g., VM with FS data, network data management protocol (NDMP) data, etc.), large workloads with critical priority (e.g., mission critical application data), etc.

As used herein, a “policy” is a collection of information, such as a backup policy or other data protection policy, that includes, for example (but not limited to): identity of source data that is to be protected, backup schedule and retention requirements for backed up source data, identity of an SLA (or a rule) that applies to source data, identity of a target device where source data is to be stored, etc.

As used herein, the term “backup” is intended to be broad in scope. In this manner, example backups (in connection with which embodiments disclosed herein) may be employed include (but not limited to): full backups, partial backups, clones, snapshots, incremental backups, differential backups, etc.

As used herein, “data retention” is a period of time, with a definite start and end, within which the data should be retained in a storage device. For example, a set of user requirements and/or technical considerations (e.g., security considerations, performance considerations, etc.) of a data center may be used to generate a data retention policy specifying that user data should be retained in the database for seven years.

As used herein, a “rule” is a guideline used by an SLA component to select a particular target device (or target devices), based on the ability of the target device to meet requirements imposed by the SLA. For example, a rule may specify that an HDD having a particular performance parameter should be used as the target device. A target device selected by the SLA component may be identified as part of a backup policy or other data protection policy.

Further, while a single server (e.g., 140A) is considered above, the term “server” includes any collection of systems or sub-systems that individually or jointly execute a set, or multiple sets, of instructions to provide one or more computer-implemented services. For example, a single server may provide a computer-implemented service on its own (i.e., independently) while other servers may provide a second computer-implemented service cooperatively (e.g., each of the other servers may provide similar or different services that form the cooperatively provided service).

As described above, a server (e.g., 140A) may provide any quantity and any type of computer-implemented services. To provide computer-implemented services, the server may be a heterogeneous set, including a collection of physical components/resources (discussed above) configured to perform operations of the server and/or otherwise execute a collection of logical components/resources (discussed above) of the server.

In one or more embodiments, a server (e.g., 140A, 140Z, etc.) may implement a management model to manage the aforementioned computing resources in a particular manner. The management model may give rise to additional functionalities for the computing resources. For example, the management model may automatically store multiple copies of data in multiple locations when a single write of the data is received. By doing so, a loss of a single copy of the data may not result in a complete loss of the data. Other management models may include, for example, adding additional information to stored data to improve its ability to be recovered, methods of communicating with other devices to improve the likelihood of receiving the communications, etc. Any type and number of management models may be implemented to provide additional functionalities using the computing resources without departing from the scope of the embodiments disclosed herein.

One of ordinary skill will appreciate that a server (e.g., 140A, 140Z, etc.) may perform other functionalities without departing from the scope of the embodiments disclosed herein.

In one or more embodiments, a server (e.g., 140A, 140Z, etc.) may be implemented as a computing device (e.g., 800, FIG. 8). The computing device may be, for example, a mobile phone, a tablet computer, a laptop computer, a desktop computer, a server, a distributed computing system, or a cloud resource. The computing device may include one or more processors, memory (e.g., RAM), GPUs, NPUs, TPUs, and persistent storage (e.g., HDDs, SSDs, etc.). The computing device may include instructions, stored in the persistent storage, that when executed by the processor(s) of the computing device cause the computing device to perform the functionality of the server described throughout the application.

Alternatively, in one or more embodiments, similar to a client (e.g., 110A, 110N, etc.), the server may also be implemented as a logical device.

In one or more embodiments, AI model training (e.g., distributed AI model training using a rail optimized scale-out network) involves multiple processes/steps. Two such processes that have an impact on the performance of AI model training are checkpointing and loading of “training” data into processing units (e.g., GPUs, DPUs, NPUs, TPUs, CPUs, etc.). Checkpointing refers to the process of saving the intermediate states or parameters (also referred to as checkpoint data) of an AI model during training at regular intervals. This allows the training process to be paused and resumed from a saved point without having to start over, ensuring that progress is not lost due to interruptions, for example, due to computing resource failures, time limits, or other constraints. Checkpointing is a crucial aspect of training large and complex AI models, particularly in deep learning, where training can take a long time and involve extremely large datasets.

Further, the amount of time that a given processing unit is paused is directly related to the amount of time required to transmit the checkpoint data from the unit to persistent storage, where the persistent storage (e.g., of the storage system) may be located outside of a related server (e.g., 140A) on which the unit is executing. The amount of time required is most significantly affected (or impacted) by latency in the network path (which may include multiple hops) between the server and the storage. Any decrease in the amount of time a processing unit is paused during the checkpointing process may improve the utilization of the unit and, as a result, decrease the amount of time required to, for example, train an AI model and decrease the amount of computing resources expended to train the AI model.

In one or more embodiments, all, or a portion, of the components of the system (100) may be operably connected each other and/or other entities via any combination of wired and/or wireless connections. For example, the aforementioned components may be operably connected, at least in part, via a network (e.g., the scale-out network (130) or any other network topology). Further, all, or a portion, of the components of the system (100) may interact with one another using any combination of wired and/or wireless communication protocols.

In one or more embodiments, the scale-out network (130) may be a distributed networking architecture designed to handle increases in data traffic and workloads by adding more resources (e.g., servers, network devices, etc.). The components of the scale-out network (130) may be connected via a network fabric (see e.g., FIG. 2.1). As used herein, a network fabric may refer to the interconnected topology and structure of network components/devices (e.g., network switches, routers, links, etc.) in the scale-out network that operate together to provide high-speed, low-latency data transmission across the system (100).

In one or more embodiments, the network/communication fabric may be implemented using a spine-leaf topology (see FIG. 2.1), in which every leaf network device connects to each spine network device. Each component of the system (100) may directly connect to the leaf network devices. Those skilled in the art will appreciate that while FIG. 1.1 indicates a scale-out network, any other type of network (or network topology) may be used without departing from the scope of the embodiments disclosed herein.

In one or more embodiments, the scale-out network (130) may represent a (decentralized or distributed) computing network and/or fabric configured for computing resource and/or messages exchange among registered computing devices (e.g., the clients, the servers, the storage, etc.). As discussed above, components of the system (100) may operatively connect to one another through the network (e.g., a SAN, a personal area network (PAN), a LAN, a metropolitan area network (MAN), a WAN, a mobile network, a wireless LAN (WLAN), a virtual private network (VPN), an intranet, the Internet, etc.) enabled by the network fabric, which facilitates the communication of signals, data, and/or messages. In one or more embodiments, the scale-out network (130) may be implemented using any combination of wired and/or wireless network topologies, and the network may be operably connected to the Internet or other networks. Further, the network may enable interactions between, for example, the clients and the servers through any number and type of wired and/or wireless network protocols (e.g., TCP, UDP, IPv4, etc.).

As discussed above, the scale-out network (130) may encompass various interconnected, network-enabled subcomponents (e.g., network switches (see e.g., FIG. 2.1), routers, gateways, cables etc.) that may facilitate communications between the components of the system (100). In one or more embodiments, the network-enabled subcomponents may be capable of: (i) performing one or more communication schemes (e.g., IP communications, Ethernet communications, etc.), (ii) being configured by one or more components in the network, and (iii) limiting communication(s) on a granular level (e.g., on a per-port level, on a per-sending device level, etc.). The subcomponents (e.g., network devices) may be implemented using hardware, software, or any combination thereof.

In one or more embodiments, before communicating data over the scale-out network (130), the data may first be broken into smaller batches (e.g., data packets, data blocks, etc.) so that larger size data can be communicated efficiently. For this reason, the network-enabled subcomponents may break data into data packets. The network-enabled subcomponents may then route each data packet in the scale-out network (130) to distribute network traffic uniformly.

In one or more embodiments, the network-enabled subcomponents may decide how real-time network traffic and non-real-time network traffic should be managed in the scale-out network (130). In one or more embodiments, the real-time network traffic may be high-priority (e.g., urgent, immediate, etc.) network traffic. For this reason, data packets of the real-time network traffic may need to be prioritized in the scale-out network (130). The real-time network traffic may include data packets related to, for example (but not limited to): videoconferencing, web browsing, voice over Internet Protocol (VoIP), etc.

While FIG. 1.1 shows a configuration of components, other system configurations may be used without departing from the scope of the embodiments disclosed herein.

Turning now to FIG. 1.2, FIG. 1.2 shows a diagram of a server (e.g., Server A (140A)) in accordance with one or more embodiments disclosed herein. More specifically, FIG. 1.2 shows additional details about a server in accordance with one or more embodiments disclosed herein. As being a physical computing device, the server (140A) includes a set of DPUs (e.g., DPU A (125A), DPU N (125N), etc.) operatively connected to a set of processing units (PUs) (e.g., PU A (128A), PU N (128N), etc.) (in which the set of PUs may include any types of PUs such as GPUs, NPUs, TPUs, CPUs, etc.) via a PCIe fabric (127), and a set of NICs (e.g., NIC A (123A), NIC Z (123Z), etc.) (e.g., to execute multiple AI workloads that use same network connections on the scale-out network (e.g., 130, FIG. 1.1)). The server (140A) may include additional, fewer, and/or different components without departing from the scope of the embodiments disclosed herein. Each component may be operably connected to any of the other components via any combination of wired and/or wireless connections. Each component illustrated in FIG. 1.2 is discussed below.

In one or more embodiments, the server (140A) may communicate with, transmit data to, and/or receive data from other servers (e.g., 140Z, FIG. 1.1) and the clients (e.g., 110A, FIG. 1.1) via the scale out network (e.g., 130, FIG. 1.1).

In one or more embodiments, the PCIe fabric (127) is a high-speed, point-to-point interconnect architecture that allows the set of PUs (e.g., 128A, 128N, etc.) and the set of DPUs (e.g., 125A, 125N, etc.) (as well as other hardware components (not shown) in the server) to communicate directly with each other using the PCIe protocol and one or more PCIe switches.

Further, the set of DPUs (e.g., 125A, 125N, etc.) and the set of PUs (e.g., 128A, 128N, etc.) may communicate and/or transmit data to each other via the PCIe fabric (127) using PCIe interfaces located on each DPU and PU. Some embodiments may include PCIe switches between the DPUs/NICs and PUs. In another embodiment, a Compute Express Link (CXL) bus, or other interconnect technologies, may be used to connect a PU (e.g., a GPU, an NPU, a TPU, etc.) and associated DPU(s). In one or more embodiments, the server (140A) may also include other hardware components/resources such as, for example, processors, volatile storage (e.g., memory), non-volatile storage (e.g., HDDs, SSDs, etc.), etc.

As used herein, a GPU (e.g., 128A, 128N, etc.) is a specialized electronic component that includes multiple cores (also referred to as GPU cores) arranged to enable high-performance parallel computing tasks. A GPU also includes large amounts of volatile memory (e.g., memory sufficient to store 80 GB of data) to support the parallel processing of the multiple GPU cores. For AI model training and AI inferencing, a GPU (e.g., 128A, 128N, etc.) may provide/implement additional functionalities without departing from the scope of the embodiments disclosed herein.

As used herein, a DPU (e.g., 125A, 125N, etc.) is a specialized electronic component that includes one or more network interfaces and is designed to offload various networking tasks (e.g., packet processing, encryption, data compression, network virtualization, etc.) from the server's CPU (not shown). A DPU (e.g., 125A, 125N, etc.) may include local volatile storage (e.g., a DPU with expanded memory) in the form of a cache (e.g., Cache A (126A), Cache N (126N), etc.). Those skilled in the art will appreciate that (i) the cache may be implemented using any other form of volatile and/or non-volatile storage (e.g., RAM, Flash memory, magnetic memory, etc.) and/or (ii) may be located in a GPU or a Top-of-Rack (ToR) switch without departing from the scope of the embodiments disclosed herein.

Further, in the server (140A), each of the DPUs (e.g., 125A, 125N, etc.) may be mapped 1:1 to a PU (e.g., 128A, 128N, etc.). For example, PU A (128A) may be mapped to DPU A (125A). Once mapped, the cache (e.g., 126A) of DPU A (125A) may be used to store checkpoint data from PU A (128A) as well as data that is to be used by PU A (128A) for AI model training and/or AI inferencing. A DPU (e.g., 125A, 125N, etc.) may provide additional functionalities without departing from the scope of the embodiments disclosed herein.

As discussed above, each of the DPUs in the server (140A) may include cache (e.g. 126A, 126N, etc.). This cache (e.g., one or more memory regions) may be sized such that the cache can temporarily store checkpoint data (or data blocks) that are (i) generated by a corresponding PU(s) in the server (140A) or (ii) obtained from a storage device/system of the system (e.g., 100, FIG. 1.1). In this manner, a PU (e.g., 128A, 128N, etc.) may only be paused for the time the PU takes to obtain the checkpoint data and then transmit the checkpoint data to a related DPU (which may be mapped 1:1 or 1:N to the PU) via the PCIe fabric (127). Once the checkpoint data has been stored in the cache, the PU can resume execution of, for example, the AI workload. By locally storing the checkpoint data in the cache, the PU can resume operation prior the checkpoint data being stored in, for example, the storage system.

In one or more embodiments, a NIC (e.g., 123A, 123Z, etc.) (e.g., a network adapter that ensures a dedicated network port for each PU) may implement and/or support one or more protocols to enable the communication between the server (140A) with one or more other devices (e.g., other servers in the system, one or more clients, etc.). For example, the NIC may enable the server (140A) to be operatively connected, via Ethernet, using a TCP/IP protocol to form a “network fabric” and enable the communication of data between the server (140A) and other external entities. In one or more embodiments, each server within the system (e.g., 100, FIG. 1.1) may be given a unique identifier (e.g., an IP address) to be used when utilizing one or more protocols.

In one or more embodiments, as being a super NIC, NIC A (123A) may include/host an OSFP cage that hosts an OSFP module (132) (e.g., a physical computing device). NIC A (123A) may operate in, at least, three operation modes: (i) the mode (not shown) where NIC A is configured with a single port (e.g., a single InfiniBand port), which provides an XDR of 800 GB/s (that operates as four times 200 GB/s), (ii) the mode (not shown) where NIC A is reconfigured to support two Ethernet ports (each supporting 400 GbE), and (iii) the mode (shown in FIG. 1.2) where NIC A is reconfigured to support eight Ethernet ports (each supporting 100 GbE data transfer rate network protocol) (e.g., Port A (129A), Port N (129N), etc.). In one or more embodiments, each of the eight serial 100 GbE ports of the OSFP module (132) may be exposed as an eight 100 GbE link/lane (e.g., Link A (131A), Link N (131N), etc.) to the network (e.g., a rail optimized scale-out network). Further, each of the eight 100 GbE links may be electrically connected to NIC A (123A).

In one or more embodiments, based on the operation mode (e.g., based on the mode described in (iii)), for example, PU A (128A) may infer that the server (140A) has eight NICs/interfaces (each supporting 100 GbE) that are assigned to PU A (128A) and accessible through relevant PCIe buses (even though there is only one NIC (e.g., 123A) is assigned to PU A (128A)).

One of ordinary skill will appreciate that NIC A (123A) may perform other functionalities (e.g., being used by a PU (e.g., 128A) and/or a DPU (e.g., 125A) of the server (140A)) without departing from the scope of the embodiments disclosed herein. NIC A (123A) may be implemented as a computing device using hardware (e.g., any number of integrated circuits for processing computer readable instructions), software (e.g., a computer program), or any combination thereof.

Separately, compared to NIC A (123A), NIC Z (123Z) may have/perform additional, fewer, and/or different components/functionalities without departing from the scope of the embodiments disclosed herein.

In one or more embodiments, the set of DPUs (e.g., 125A, 125N, etc.), the set of PUs (e.g., 128A, 128N, etc.), the PCIe fabric (127), and the set of NICs (e.g., 123A, 123Z, etc.) may be utilized in isolation and/or in combination to provide the aforementioned functionalities. These functionalities may be invoked using any communication model including, for example, message passing, state sharing, memory sharing, etc.

In one or more embodiments, instead of staging data (e.g., checkpoint data) with caches (e.g., Cache A (126A), Cache N (126N), etc.) in a server (e.g., Server A (140A)), the data may be staged in the cache (or memory) of one or more ToR switches in a related server rack, in which a server hosting one or more PUs is located. Accordingly, instead of caching the data at the DPU level or server level (e.g., FIG. 1.2), the data may be cached at the server rack level. While transmission of the data to a ToR switch may require two hops (e.g., PU→DPU (or NIC)→ToR switch), the effective bit rate for these two hops is typically substantially higher than the bit rate (e.g., I/O storage rate) of a storage system.

Turning now to FIG. 2.1, FIG. 2.1 shows an example two-tier scale-out fabric/network in accordance with one or more embodiments disclosed herein. The example, illustrated in FIG. 2.1 and described below, is for explanatory purposes only and not intended to limit the scope disclosed herein.

In one or more embodiments, the two-tier scale-out network, shown in FIG. 2.1, may be an example of the scale-out network discussed above in reference to FIG. 1.1. Further, a server (e.g., 204A, 214A, etc.) may be an example of the server discussed above in reference to FIG. 1.2. Referring the FIG. 2.1, the scale-out network may be based on a rail optimized network architecture (discussed below).

In general, AI model training necessitates server clusters significantly larger than eight servers/nodes (to perform, for example, collective communications/operations (e.g., all-gather, all-reduce, etc.)). When scaling beyond eight servers, the network architecture should be carefully considered. As discussed above, each PU (e.g., 128A, FIG. 1.2) may be equipped with a dedicated NIC (e.g., 123A, FIG. 1.2), enabling that PU's communication with other PUs in other servers. In view of this, each PU can access other NICs as needed, even though each PU uses its local NIC.

In order to achieve high-BW and low-latency over various interconnects, and considering the aforementioned points, a scale-out network that is based on a rail optimized network architecture is considered as a recommended solution for large server cluster to perform, at least, AI model training and/or AI inferencing. Referring to FIG. 2.1, the rail optimized network architecture (which is a two-tier architecture) includes one or more leaf network switches (e.g., 208A, 208N, 216A, 216N, etc.) and one or more spine network switches (e.g., 207A, 207N, etc.). In this architecture, (i) each NIC (of a related server (e.g., 204A, 206A, 206N, etc.)) is operatively connected to a different network “leaf” switch, called a “rail” leaf network switch (e.g., Network Switch (208A) may be “Rail 1” switch, Network Switch (208N) may be “Rail 2” switch) (said another way, a network rail may be an independent subnetwork within the rail optimized network architecture that is generated/supported by a related “rail” leaf network switch). In this architecture, rail switches (or rail leaf network switches) are interconnected at an upper tier (that is formed by spine network switches).

Further, this architecture enables/provides (i) a direct scale-out fabric communication only between PUs that belong to the same rail (or rail switch), (ii) a scale-up fabric communication (or an “intra-node” communication) between PUs within the same server/node (e.g., 204A) to cross rails, and (iii) scalability and connectivity through the upper tier (especially in times where a PU-to-PU communication across different servers may not take the optimum path (formed by leaf network switches) and the upper tier may need to provide connectivity between different rails to enable the communication).

For example, in order to communicate with PU 8 on Server (206A) (which is hosted by Server Rack (202N)), PU 4 on Server (204A) may: (i) transfer its data into the memory/cache of (or related to) PU 8 on Server (204A) (cross the rails), and then PU 8 on Server (204A) can communicate through NIC 8 on Server (204A) with PU 8 on Server (206A), coupled with NIC 8 on Server (206A), or (ii) transfer its data to NIC 4 on Server (204A), which would be able to reach, through the upper tier “spine” network switch, NIC 8 on Server (206A), coupled with PU 8 on Server (206A).

As yet another example, consider a scenario where PU R on Server (204A) (which is part of Rail Pod 1) wants to communicate (e.g., in order to send training data) with PU B on Server (212A) (which is part of Rail Pod 64). In this scenario, PU R may send the data upstream to “Rail 1” leaf switch (e.g., 208A) (where PU R in each server within Rail Pod 1 is connected to Rail 1 leaf switch), and then Rail 1 leaf switch may forward the data upstream to Spine Switch 1 (e.g., 207A). Thereafter, Spine Switch 1 may send the data downstream to “Rail 3” leaf switch (e.g., 216A) (where PU B in each server within Rail Pod 64 is connected to Rail 3 leaf switch). Rail 3 leaf switch may then forward the data downstream to PU B on Server (212A). As indicated in the aforementioned examples, the rail optimized architecture/topology can be considered to build a scale-out fabric (so that collective communication functions can still be performed in case of a failure in the fabric).

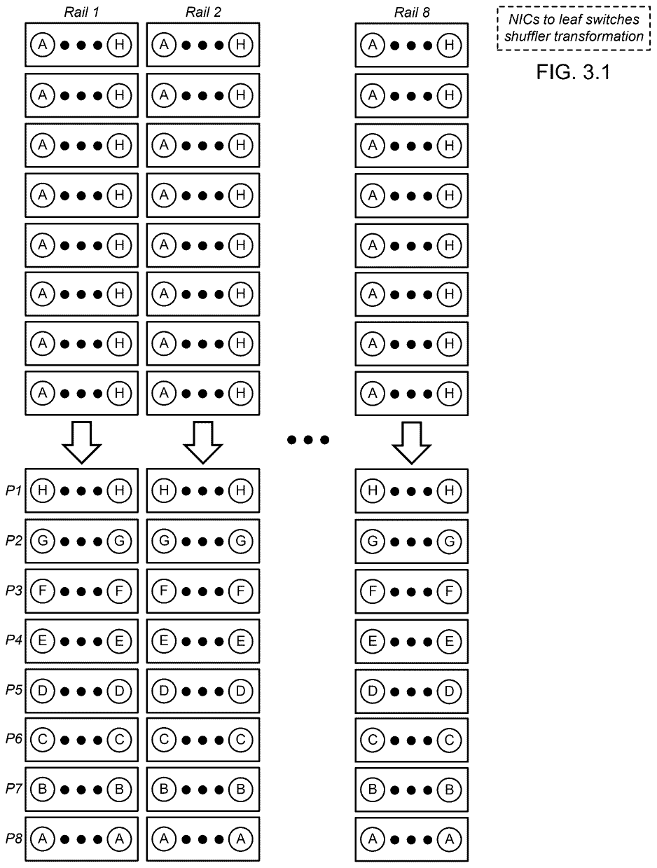

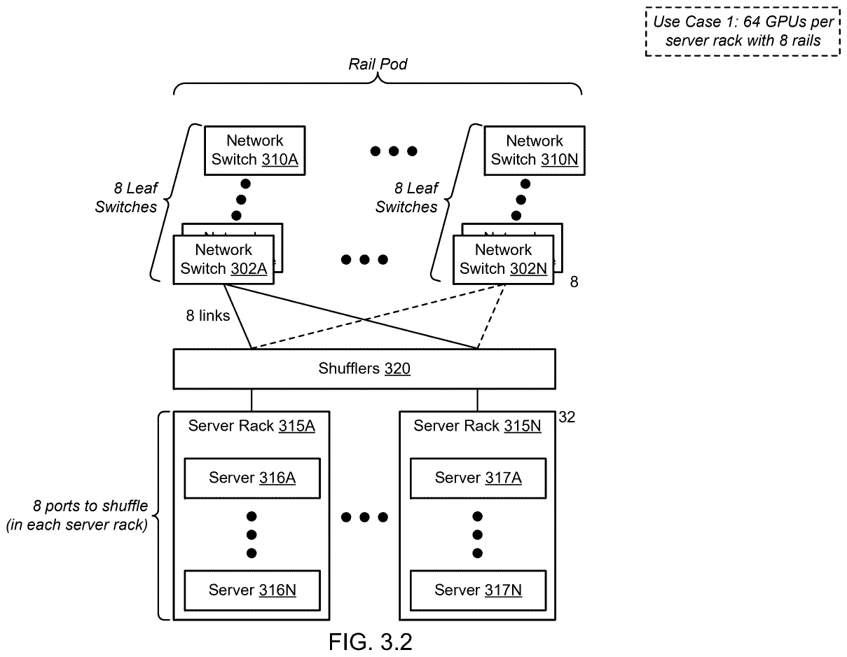

Continuing with the discussion of FIG. 2.1) (i) each rail pod (of the 64 rail pods/groups) houses/hosts 32 server racks (e.g., Rail Pod 1 houses Server Rack (202A), Server Rack (202N), etc.), (ii) each server rack houses 8 servers (e.g., Server Rack (202A) houses Server (204A), Server (204N), etc.) (total number of servers in the fabric: 8×32×64=16,384), (iii) each server (e.g., 140A, FIG. 1.2) is equipped with eight PUs and related eight NICs (where each NIC is coupled to a PU (via a PCIe link)), (iii) in a server rack, each set of NICs (e.g., a first set of NICs across the eight servers in the rack, a second set of NICs across the eight servers in the rack, etc.) is connected to an optical shuffler (or an optical shuffler device) (see FIG. 3.2), which is connected to a corresponding “rail” leaf network switch (e.g., 208A, 208N, etc.) (8 leaf switches (in total) are assigned to each rail pod), and (iv) each leaf network switch (e.g., 208A, 208N, etc.) is connected to an optical shuffler (see FIG. 3.3) (using 8 links/cables) that is connected to a corresponding spine network switch (e.g., 207A, 207N, etc.) (using a link), where the fabric includes 256 spine network switches (in total).

As used herein, a cable may refer to an electrical conductor cable such as copper twinax Direct Attach Cable (DAC) cable, an optical cable such as optical fiber, and/or other cabling known in the art.

In one or more embodiments, a server rack (e.g., 202A) may be a chassis (e.g., a mechanical structure) configured to house (or otherwise locate) one or more servers/blades (e.g., Server (204A), Server (204N), etc.) and their components. Similar to FIG. 1.2, a server (e.g., Server (204A), Server (204N), etc.) may include any instrumentality or aggregate of instrumentalities operable to compute, classify, process, transmit, receive, retrieve, originate, switch, store, display, manifest, detect, record, reproduce, handle, and/or utilize any form of data for business, management, entertainment, or other purposes.

As will be appreciated by one of skill in the art in possession of the present disclosure, a server rack (in the fabric) may host one or more leaf network switches/devices (e.g., 208A, 208N, etc.). Similarly, another server rack (in the fabric) may host one or more spine network switches/devices (e.g., 207A, 207N, etc.).

Referring to FIG. 2.1, the example two-tier scale-out fabric (that may represent the scale-out fabric demonstrated in FIG. 1.1) includes functionality to facilitate data transfer between connected components (e.g., leaf network switches, servers, optical shufflers, spine network switches, etc.). For example, a network switch may both transmit and receive data from the same pathway facilitated by the fabric. The network fabric may also include the functionality to identify network congestion via one or more network switches. One of ordinary skill in the art will appreciate that the example two-tier scale-out fabric may perform other functionalities without departing from the scope of the embodiments disclosed herein.

In one or more embodiments, each network switch (e.g., 207A, 208A, etc.) may be a physical, high-performance computing device configured to connect network servers, storage devices, and other network appliances within enterprise (e.g., on-premises and/or cloud computing infrastructure) environments. Further, each network switch may include 512 ports (e.g., a radix 512 network switch), where half of these ports (256) may be connected to corresponding servers (over related optical shufflers, see FIG. 3.2), while the remaining half may be connected to corresponding spine network switches (over related optical shufflers, see FIG. 3.3). One of ordinary skill in the art will appreciate that a network switch may perform other functionalities without departing from the scope of the embodiments disclosed herein.

Turning now to FIG. 2.2, FIG. 2.2 shows an example set of parallel fabrics (or fabric planes) in accordance with one or more embodiments disclosed herein. Referring to FIGS. 1.1-2.1, a client (e.g., 110A) is operatively connected to a server rack (e.g., 202A) over the scale-out network (e.g., 130), which is a two-tier scale-out fabric. Referring to FIG. 2.2 and in order to support multiplane networking, the scale-out network/fabric may be structured as a set of disjoint parallel planes (DPPs) (or a set of disjoint parallel fabrics) to support an operation mode of a NIC (e.g., NIC A, NIC N, etc.) of a server (e.g., 204A, 206A, etc.), in which each plane (e.g., Plane 1, Plane 8, etc.) of the DPPs includes a set of high-radix leaf network switches and a set of high-radix spine network switches. Said another way, to leverage a high-radix network switch (e.g., 207A, 208A, etc.) along with eight Ethernet ports (each supporting 100 GbE) (i.e., the 8×100 GbE mode) of a NIC of a server, the scale-out fabric is structured as a set of DPPs.

Referring to FIG. 1.2, in order to support the different modes (or operation modes), a NIC (123A) may host an OSFP cage that hosts OSFP connectors. Separately, network switches (e.g., 207A, 208A, etc.) that are used in the fabric may also use OSFP connectors. By structuring the scale-out fabric (e.g., by dividing each network rail into eight planes), the “set of DPPs” mode of operation can be achieved, where (i) eight 100 GbE links of each OSFP module (where eight 100 GbE ports are exposed as eight 100 GbE links) are extracted and connected to a different leaf network switch (e.g., 208A, 208N, etc.), which belongs to an appropriate plane (of the eight parallel fabric planes), (ii) each leaf network switch (or leaf network switch port) connecting to a NIC can aggregate 100GbE links of eight distinct NICs, (iii) eight 100 GbE links of each leaf network switch port connecting to spine network switches (e.g., 207A, 207N, etc.) are extracted and connected to a different spine switch (in the same plane), and (iv) each spine network switch (or spine network switch port) connecting to leaf network switches can aggregate 100 GbE links of eight distinct leaf network switches.

Turning now to FIG. 2.3, FIG. 2.3 shows an optical shuffler (or an optical shuffler device) in accordance with one or more embodiments disclosed herein. In one or more embodiments, the shuffler may be an “8 ports to 8 ports” shuffler, as an OSFP connector (used by a related NIC and/or a related network switch) has 8 links/lanes. Referring to FIG. 2.3, FIG. 2.3 shows a transformation performed by the shuffler when used between NICs (of a corresponding servers (e.g., 204A, 204N, etc., FIG. 2.1)) and leaf network switches (e.g., 208A, 208N, etc., FIG. 2.1) in order to split each NIC's connector into the eight fabric planes (see FIG. 2.2).

Referring to FIG. 2.3 (left side), the top “A B C D E F G H” may represent links/lanes that are exposed out of an OSFP module (e.g., 132, FIG. 1.2) of a related NIC (e.g., 123A, FIG. 1.2), in which “A” may be Link A (e.g., 131A, FIG. 1.2) and “H” may be Link H (e.g., 131N, FIG. 1.2). As indicated on the left side, the optical shuffler takes 8 NICs (or 8 NIC ports, where each NIC has a single main port (or OSFP module)) (for example, within a server rack) that belongs to the same network rail (i.e., the same leaf network switch or the same rail network switch) and shuffles/mixes the ports to generate 8 “arranged” NIC ports, so that each of the arranged NIC ports can be connected to a related “rail” leaf network switch in a corresponding plane (e.g., Plane 1, Plane 2, etc.) of the set of DPPs (see FIG. 2.2).

For example, after shuffling (i) a first set of links (e.g., “A B C D E F G H”) of a first NIC port of a first server, (ii) a second set of links (e.g., “A B C D E F G H”) of a second NIC port of a second server, (iii) a third set of links (e.g., “A B C D E F G H”) of a third NIC port of a third server, (iv) a fourth set of links (e.g., “A B C D E F G H”) of a fourth NIC port of a fourth server, (v) a fifth set of links (e.g., “A B C D E F G H”) of a fifth NIC port of a fifth server, (vi) a sixth set of links (e.g., “A B C D E F G H”) of a sixth NIC port of a sixth server, (vii) a seventh set of links (e.g., “A B C D E F G H”) of a seventh NIC port of a seventh server, and (viii) an eighth set of links (e.g., “A B C D E F G H”) of an eighth NIC port of an eighth server, the optical shuffler may obtain (refer to the right side of FIG. 2.3) (i) a first port (including a set of arranged/separated links (e.g., “H H H H H H H H”)) that belongs to (or would be connected to) a related “rail” leaf network switch of Plane 1 of the set of DPPs, (ii) a second port (including a set of arranged links (e.g., “G G G G G G G G”)) that belongs to (or would be connected to) a related “rail” leaf network switch of Plane 2 of the set of DPPs, (iii) a third port (including a set of arranged links (e.g., “F F F F F F F F”)) that belongs to (or would be connected to) a related “rail” leaf network switch of Plane 3 of the set of DPPs, (iv) a fourth port (including a set of arranged links (e.g., “E E E E E E E E”)) that belongs to (or would be connected to) a related “rail” leaf network switch of Plane 4 of the set of DPPs, (v) a fifth port (including a set of arranged links (e.g., “D D D D D D D D”)) that belongs to (or would be connected to) a related “rail” leaf network switch of Plane 5 of the set of DPPs, (vi) a sixth port (including a set of arranged links (e.g., “C C C C C C C C”)) that belongs to (or would be connected to) a related “rail” leaf network switch of Plane 6 of the set of DPPs, (vii) a seventh port (including a set of arranged links (e.g., “B B B B B B B B”)) that belongs to (or would be connected to) a related “rail” leaf network switch of Plane 7 of the set of DPPs, and (viii) an eighth port (including a set of arranged links (e.g., “A A A A A A A A”)) that belongs to (or would be connected to) a related “rail” leaf network switch of Plane 8 of the set of DPPs.

In one or more embodiments, the optical shuffler may be implemented as a computing device using hardware (e.g., any number of integrated circuits for processing computer readable instructions), software (e.g., a computer program), or any combination thereof. In one or more embodiments, the optical shuffler may be hosted by a server rack.

Turning now to FIG. 2.4, FIG. 2.4 shows an optical shuffler (or an optical shuffler device) in accordance with one or more embodiments disclosed herein. In one or more embodiments, similar to FIG. 2.3, the shuffler may be an “8 ports to 8 ports” shuffler. Referring to FIG. 2.4, FIG. 2.4 shows a transformation performed by the shuffler when used between leaf network switches (e.g., 208A, 208N, etc., FIG. 2.1) and spine network switches (e.g., 207A, 207N, etc., FIG. 2.1) within a single fabric plane.

Referring to FIG. 2.4 (left side), the optical shuffler takes 8 “arranged” ports (from 8 different “rail” leaf network switches) and shuffles the ports to generate 8 “mixed” ports, so that each of the mixed ports can be connected to related spine network switches in a related fabric plane (the switches that performs the cross-rail function (described above in reference to FIG. 2.1) in the rail optimized scale-out fabric).

For example, after shuffling, (i) the first port that belongs to a related “rail” leaf network switch of Plane 1, (ii) the second port that belongs to a related “rail” leaf network switch of Plane 2, (iii) the third port that belongs to a related “rail” leaf network switch of Plane 3, (iv) the fourth port that belongs to a related “rail” leaf network switch of Plane 4, (v) the fifth port that belongs to a related “rail” leaf network switch of Plane 5, (vi) the sixth port that belongs to a related “rail” leaf network switch of Plane 6, (vii) the seventh port that belongs to a related “rail” leaf network switch of Plane 7, and (viii) the eighth port that belongs to a related “rail” leaf network switch of Plane 8, the optical shuffler may obtain (refer to the right side of FIG. 2.4) (i) a first mixed port (including a set of links (e.g., “H G F E D C B A”)) that would be connected to related spine network switches in a related fabric plane, (ii) a second mixed port (including a set of links (e.g., “H G F E D C B A”)) that would be connected to related spine network switches in a related fabric plane, (iii) a third mixed port (including a set of links (e.g., “H G F E D C B A”)) that would be connected to related spine network switches in a related fabric plane, (iv) a fourth mixed port (including a set of links (e.g., “H G F E D C B A”)) that would be connected to related spine network switches in a related fabric plane, (v) a fifth mixed port (including a set of links (e.g., “H G F E D C B A”)) that would be connected to related spine network switches in a related fabric plane, (vi) a sixth mixed port (including a set of links (e.g., “H G F E D C B A”)) that would be connected to related spine network switches in a related fabric plane, (vii) a seventh mixed port (including a set of links (e.g., “H G F E D C B A”)) that would be connected to related spine network switches in a related fabric plane, and (viii) an eighth mixed port (including a set of links (e.g., “H G F E D C B A”)) that would be connected to related spine network switches in a related fabric plane.

In one or more embodiments, the specific way to use the optical shuffler (discussed above in reference to FIGS. 2.3-2.4) may depend on the chosen PU (e.g., a GPU, a CPU, an NPU, a TPU, etc.) platform. The following describes various use cases to discuss how to use the optical shuffler in different PU platforms.

Turning now to FIGS. 3.1-3.3, FIGS. 3.1-3.3 show an example use case in accordance with one or more embodiments disclosed herein. The example use case (64 GPUs per server rack with 8 rails (or 8 rail leaf network switches, as each server hosts 8 GPUs and 8 NICs)), illustrated in FIGS. 3.1-3.3 and described below, is for explanatory purposes only and not intended to limit the scope of embodiments disclosed herein.

Referring to FIG. 3.2, server racks (e.g., 315A, 315N, etc.), servers (e.g., 316A, 317A, etc.), and network switches (e.g., 302A, 310A, 302N, 310N, etc.) may have the same or substantially the same functionality as the liked named components in FIGS. 1.2 and 2.1. In conjunction with FIG. 3.1, FIG. 3.2 shows how to select 8 NIC ports (in each server rack (e.g., 315A), a column of NICs is considered to shuffle such as NIC 1 of Server (316A), NIC 1 of Server (316N), etc.) that belong to the same “rail” leaf network switch and how the corresponding optical shuffler of the optical shufflers (320) performs the transformation/shuffling (discussed above in reference to FIG. 2.3) on these ports. As a result of the transformation, a set of 8 ports that needs to be connected to a related rail leaf network switch in each fabric plane (discussed above in reference to FIGS. 2.2-2.3) is obtained.

Referring to FIG. 3.2, in the rail pod (which includes 32 server racks, discussed above in reference to FIG. 2.1), a first set of leaf network switches (e.g., Network Switch (302A), Network Switch (310A), etc.) may indicate a first rail that is divided into 8 planes (e.g., Plane 1 (P1) of the first rail (see FIG. 3.1), Plane 2 (P2) of the first rail (see FIG. 3.1), etc.) and an eighth set of leaf network switches (e.g., Network Switch (302N), Network Switch (310N), etc.) may indicate an eighth rail that is divided into 8 planes (e.g., Plane 1 (P1) of the eighth rail (see FIG. 3.1), Plane 2 (P2) of the eighth rail (see FIG. 3.1), etc.). For example, as a result of the transformation (or after the shuffling), a first port (an OSFP connector that includes a first set of links) may be connected to the “first rail” leaf network switch on Plane 1, a second port (an OSFP connector that includes a second set of links) may be connected to the “first rail” leaf network switch on Plane 2, etc.

Thereafter, the resulting scalable unit may (i) include 32 server racks (e.g., 315A, 315N, etc.) and each server rack may include 64 GPUs (8 servers×8 GPUs), (ii) include 4 network server racks (not shown) in between 16 server racks (on the left side of the scalable unit) and 16 server racks (on the rights side of the scalable unit), each including two fabric planes with 8 network switches per plane. As a result, each scalable unit (in this use case) may require 256 optical shufflers (320) (8 per server rack×32 racks).

In addition, when the aforementioned scalable unit is used to build a two-tier scale-out fabric (discussed above in reference to FIG. 2.1), the fabric (or the rail optimized scale-out fabric) may support up to 131,072 GPUs (64 GPUs per rack).

Referring to FIG. 3.3, network switches (e.g., 302A, 303A, 304A, 304N, etc.) may have the same or substantially the same functionality as the liked named components in FIG. 2.1. In order to perform the “leaf network switch to spine network switch” connectivity in the aforementioned fabric, each fabric plane may require the shuffler transformation discussed above in reference to FIG. 2.4. In this use case, each of the 8 “rail” leaf network switches (in a rail pod) may have 32 uplinks. The shuffling (performed by one or more of the optical shufflers (322)) occurs among 8 ports that belong to the 8 “rail” leaf network switches, resulting in 256 ports to connect to 256 spine network switches. In view of this, each rail pod may require 32 optical shufflers per fabric plane (256 optical shufflers in total).

As indicated above, in order to solve the aforementioned multi-plane problem, the optical shuffler and the transformations (that can be performed by the shuffler) discussed above in reference to FIGS. 2.3-2.4 can be used. For example, in order to connect the NICs (of servers) to the leaf network switches (see FIG. 3.1) in a scalable unit, 256 optical shufflers may be needed. Separately, in order to connect the leaf network switches (of a scalable unit) to the spine network switches, 256 optical shufflers may be needed (where, for example, a first spine network switch of a first plane and a second spine network switch of the first plane may manage a communication (to transmit training data) between a first GPU of a first server (e.g., 316A, FIG. 3.2) and a second GPU of a second server (e.g., 317A, FIG. 3.2). Thus, in order to build a two-tier scale-out fabric (discussed above in reference to FIG. 2.1), 32,768 (64×256×2) optical shufflers and 6144 (768×8; 8 planes, each with 768 network switches) network switches may be needed.

In one or more embodiments, if the desired number of GPUs is 32,000 or less (indicating a smaller network fabric), then no fabric plane shuffling is needed, because connections using groups of 4 links/lanes (from leaf network switches to spine network switches) can be supported by regular optical cables.

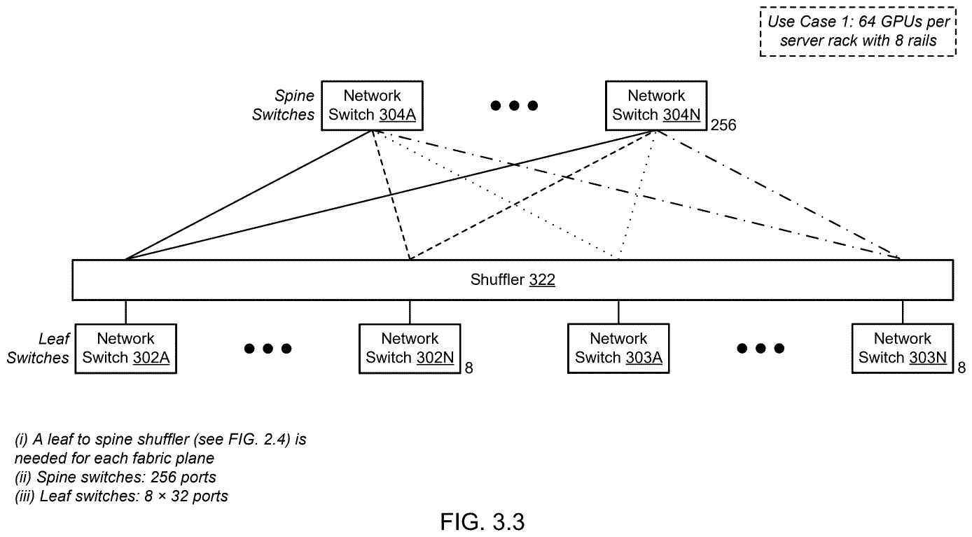

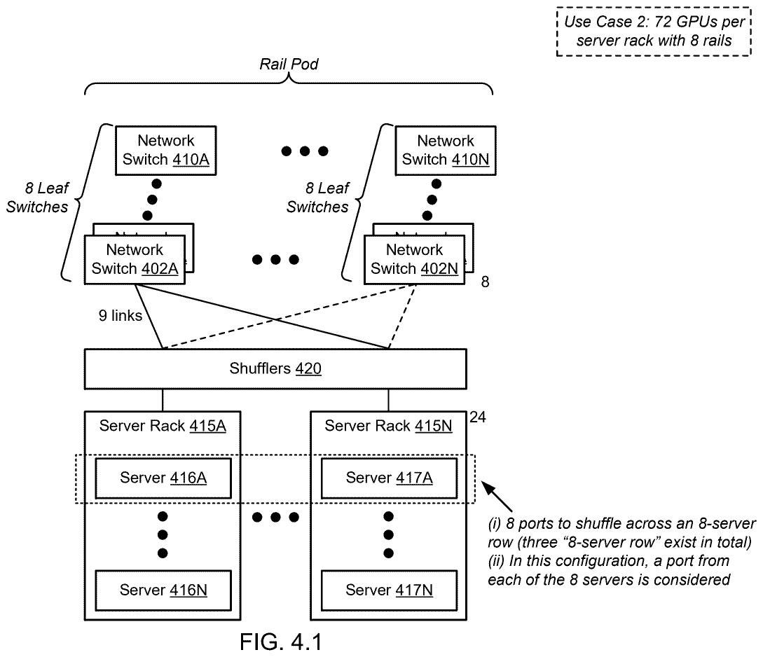

Turning now to FIGS. 4.1-4.2, FIGS. 4.1-4.2 show an example use case in accordance with one or more embodiments disclosed herein. The example use case (72 GPUs per server rack with 8 rails (or 8 rail leaf network switches), illustrated in FIGS. 4.1-4.2 and described below, is for explanatory purposes only and not intended to limit the scope of embodiments disclosed herein.

Referring to FIG. 4.1, server racks (e.g., 415A, 415N, etc.), servers (e.g., 416A, 417A, etc.), and network switches (e.g., 402A, 410A, 402N, 410N, etc.) may have the same or substantially the same functionality as the liked named components in FIGS. 1.2 and 2.1. In conjunction with FIG. 3.1, FIG. 4.1 shows how to select 8 NIC ports (across an 8-server row to shuffle (three “8-server row” exist in total, resulting in 24 server racks in each rail pod), such as NIC 1 of Server (416A) of Server Rack (415A), NIC 1 of Server (417A) of Server Rack (415N), etc.) that belong to the same “rail” leaf network switch and how the corresponding optical shuffler of the optical shufflers (420) performs the transformation/shuffling (discussed above in reference to FIG. 2.3) on these ports. As a result of the transformation, a set of 8 ports that needs to be connected to a related rail leaf network switch in each fabric plane (discussed above in reference to FIGS. 2.2-2.3) is obtained.

Referring to FIG. 4.1, in the rail pod (which includes 24 server racks, discussed above in reference to FIG. 2.1), each server rack (e.g., 415A) may host 9 servers (e.g., 416A, 416N, etc.). Further, a first set of leaf network switches (e.g., Network Switch (402A), Network Switch (410A), etc.) may indicate a first rail that is divided into 8 planes (e.g., Plane 1 (P1) of the first rail (see FIG. 3.1), Plane 2 (P2) of the first rail (see FIG. 3.1), etc.) and an eighth set of leaf network switches (e.g., Network Switch (402N), Network Switch (410N), etc.) may indicate an eighth rail that is divided into 8 planes (e.g., Plane 1 (P1) of the eighth rail (see FIG. 3.1), Plane 2 (P2) of the eighth rail (see FIG. 3.1), etc.). For example, as a result of the transformation (or after the shuffling), a first port (an OSFP connector that includes a first set of links) may be connected to the “first rail” leaf network switch on Plane 1, a second port may be connected to the “first rail” leaf network switch on Plane 2, etc. In this use case, 54 out of 64 OSFP connectors may be used on leaf network switches.

Thereafter, the resulting scalable unit may (i) include 24 server racks (e.g., 415A, 415N, etc.) and each server rack may include 72 GPUs (9 servers×8 GPUs), (ii) include 4 network server racks (not shown) in between 8 server racks (on the left side of the scalable unit) and 16 server racks (on the rights side of the scalable unit), each including two fabric planes with 8 network switches per plane. As a result, each scalable unit (in this use case) may require 216 optical shufflers (420) (8 per “8-server row”×3 (“8-server” row in total)×9 (servers per server rack)).

In addition, when the aforementioned scalable unit is used to build a two-tier scale-out fabric (discussed above in reference to FIG. 2.1), the fabric (or the rail optimized scale-out fabric) may support up to 110,592 GPUs (72 GPUs per rack).

Referring to FIG. 4.2, network switches (e.g., 402A, 403A, 404A, 404N, etc.) may have the same or substantially the same functionality as the liked named components in FIG. 2.1. In order to perform the “leaf network switch to spine network switch” connectivity in the aforementioned fabric, each fabric plane may require the shuffler transformation discussed above in reference to FIG. 2.4. In this use case, each of the 8 “rail” leaf network switches (in a rail pod) may have 27 uplinks. The shuffling (performed by one or more of the optical shufflers (422)) occurs among 8 ports that belong to the 8 “rail” leaf network switches, resulting in 216 ports to connect to 216 spine network switches. In view of this, each rail pod may require 27 optical shufflers per fabric plane (216 optical shufflers in total).

As indicated above, in order to solve the aforementioned multi-plane problem, the optical shuffler and the transformations (that can be performed by the shuffler) discussed above in reference to FIGS. 2.3-2.4 can be used. For example, in order to connect the NICs (of servers) to the leaf network switches (see FIG. 4.1) in a scalable unit, 216 optical shufflers may be needed. Separately, in order to connect the leaf network switches (of a scalable unit) to the spine network switches, 216 optical shufflers may be needed. Thus, in order to build a two-tier scale-out fabric (discussed above in reference to FIG. 2.1), 27,648 (64×216×2) optical shufflers and 5824 (728×8; 8 planes, each with 728 network switches) network switches may be needed.

In one or more embodiments, if the desired number of GPUs is 27,000 or less (indicating a smaller network fabric), then no fabric plane shuffling is needed, because connections using groups of 4 links/lanes (from leaf network switches to spine network switches) can be supported by regular optical cables.

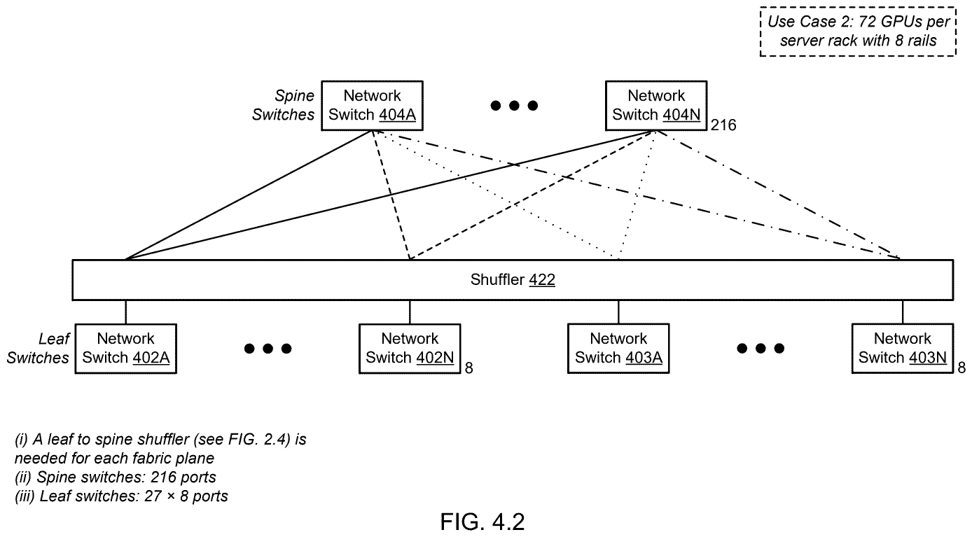

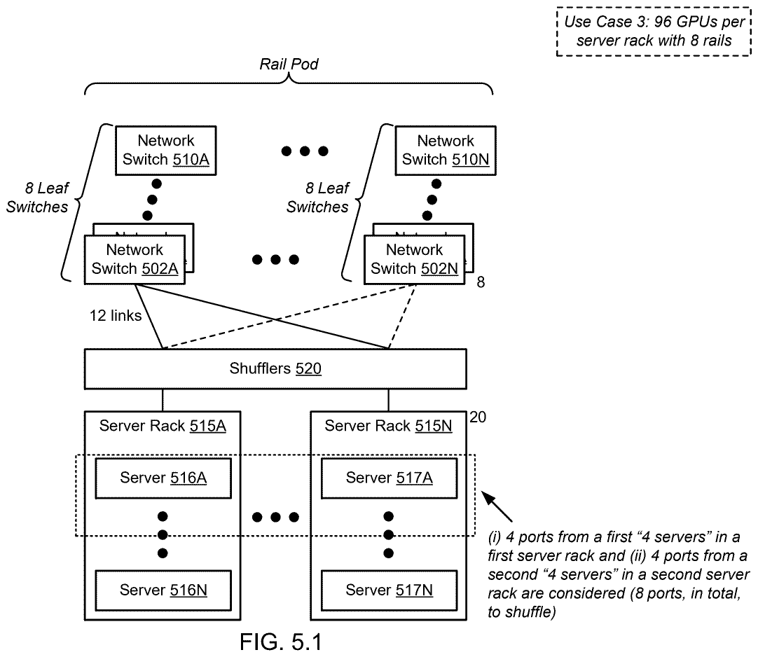

Turning now to FIGS. 5.1-5.2, FIGS. 5.1-5.2 show an example use case in accordance with one or more embodiments disclosed herein. The example use case (96 GPUs per server rack with 8 rails (or 8 rail leaf network switches), illustrated in FIGS. 5.1-5.2 and described below, is for explanatory purposes only and not intended to limit the scope of embodiments disclosed herein.

Referring to FIG. 5.1, server racks (e.g., 515A, 515N, etc.), servers (e.g., 516A, 517A, etc.), and network switches (e.g., 502A, 510A, 502N, 510N, etc.) may have the same or substantially the same functionality as the liked named components in FIGS. 1.2 and 2.1. In conjunction with FIG. 3.1, FIG. 5.1 shows how to select 8 NIC ports ((i) 4 ports from a first “4 servers” in a first server rack (e.g., 515A) and (ii) 4 ports from a second “4 servers” in a second server rack (e.g., 515N) are considered to shuffle, where each rail pod has 20 server racks) that belong to the same “rail” leaf network switch and how the corresponding optical shuffler of the optical shufflers (520) performs the transformation/shuffling (discussed above in reference to FIG. 2.3) on these ports. As a result of the transformation, a set of 8 ports that needs to be connected to a related rail leaf network switch in each fabric plane (discussed above in reference to FIGS. 2.2-2.3) is obtained.

Referring to FIG. 5.1, in the rail pod (which includes 20 server racks, discussed above in reference to FIG. 2.1), each server rack (e.g., 515A) may host 12 servers (e.g., 516A, 516N, etc.). Further, a first set of leaf network switches (e.g., Network Switch (502A), Network Switch (510A), etc.) may indicate a first rail that is divided into 8 planes (e.g., Plane 1 (P1) of the first rail (see FIG. 3.1), Plane 2 (P2) of the first rail (see FIG. 3.1), etc.) and an eighth set of leaf network switches (e.g., Network Switch (502N), Network Switch (510N), etc.) may indicate an eighth rail that is divided into 8 planes (e.g., Plane 1 (P1) of the eighth rail (see FIG. 3.1), Plane 2 (P2) of the eighth rail (see FIG. 3.1), etc.). For example, as a result of the transformation (or after the shuffling), a first port (an OSFP connector that includes a first set of links) may be connected to the “first rail” leaf network switch on Plane 1, a second port may be connected to the “first rail” leaf network switch on Plane 2, etc. In this use case, 60 out of 64 OSFP connectors may be used on leaf network switches.

Thereafter, the resulting scalable unit may (i) include 20 server racks (e.g., 515A, 515N, etc.) and each server rack may include 96 GPUs (12 servers×8 GPUs), (ii) include 4 network server racks (not shown) in between 10 server racks (on the left side of the scalable unit) and 10 server racks (on the rights side of the scalable unit), each including two fabric planes with 8 network switches per plane. As a result, each scalable unit (in this use case) may require 240 optical shufflers (520) (8×3×10 (30 shufflers per rail).

In addition, when the aforementioned scalable unit is used to build a two-tier scale-out fabric (discussed above in reference to FIG. 2.1), the fabric (or the rail optimized scale-out fabric) may support up to 122,880 GPUs (96 GPUs per rack).

Referring to FIG. 5.2, network switches (e.g., 502A, 503A, 504A, 504N, etc.) may have the same or substantially the same functionality as the liked named components in FIG. 2.1. In order to perform the “leaf network switch to spine network switch” connectivity in the aforementioned fabric, each fabric plane may require the shuffler transformation discussed above in reference to FIG. 2.4. In this use case, each of the 8 “rail” leaf network switches (in a rail pod) may have 30 uplinks. The shuffling (performed by one or more of the optical shufflers (522)) occurs among 8 ports that belong to the 8 “rail” leaf network switches, resulting in 240 ports to connect to 240 spine network switches. In view of this, each rail pod may require 30 optical shufflers per fabric plane (240 optical shufflers in total).

As indicated above, in order to solve the aforementioned multi-plane problem, the optical shuffler and the transformations (that can be performed by the shuffler) discussed above in reference to FIGS. 2.3-2.4 can be used. For example, in order to connect the NICs (of servers) to the leaf network switches (see FIG. 5.1) in a scalable unit, 240 optical shufflers may be needed. Separately, in order to connect the leaf network switches (of a scalable unit) to the spine network switches, 240 optical shufflers may be needed. Thus, in order to build a two-tier scale-out fabric (discussed above in reference to FIG. 2.1), 30,720 (64×240×2) optical shufflers and 6016 (752×8; 8 planes, each with 752 network switches) network switches may be needed.

In one or more embodiments, if the desired number of GPUs is 30,000 or less (indicating a smaller network fabric), then no fabric plane shuffling is needed, because connections using groups of 4 links/lanes (from leaf network switches to spine network switches) can be supported by regular optical cables.

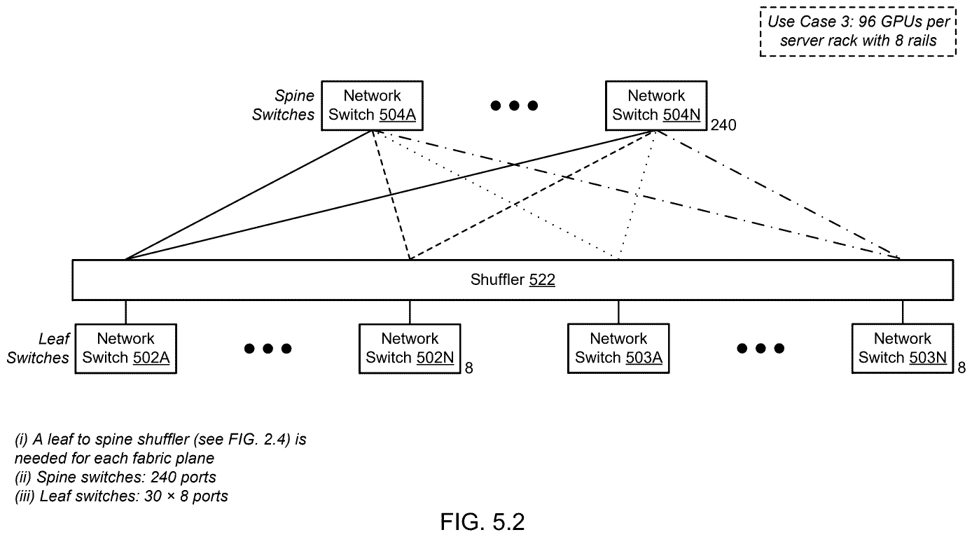

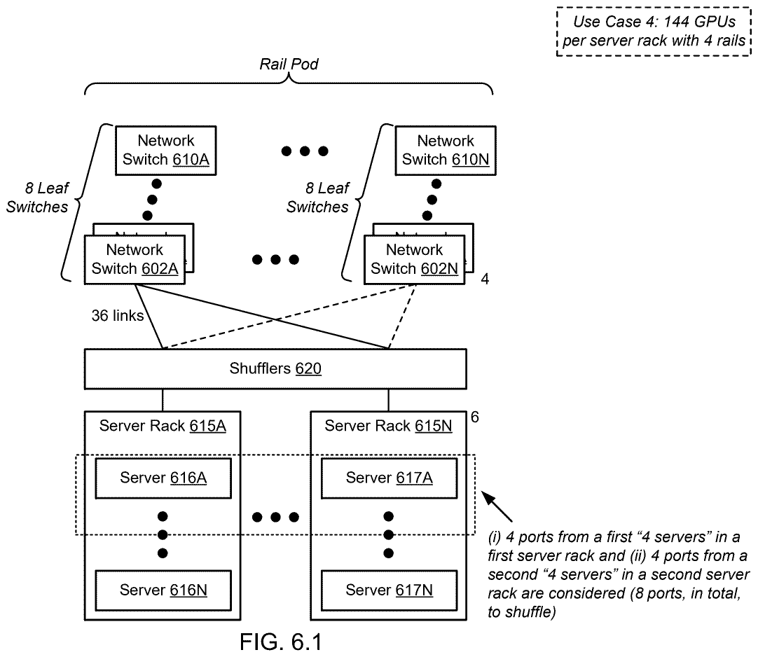

Turning now to FIGS. 6.1-6.2, FIGS. 6.1-6.2 show an example use case in accordance with one or more embodiments disclosed herein. The example use case (144 GPUs per server rack (36 servers with 4 GPUs each) with 4 rails (or 4 rail leaf network switches), illustrated in FIGS. 6.1-6.2 and described below, is for explanatory purposes only and not intended to limit the scope of embodiments disclosed herein.

Referring to FIG. 6.1, server racks (e.g., 615A, 615N, etc.), servers (e.g., 616A, 617A, etc.), and network switches (e.g., 602A, 610A, 602N, 610N, etc.) may have the same or substantially the same functionality as the liked named components in FIGS. 1.2 and 2.1. FIG. 6.1 shows how to select 8 NIC ports ((i) 4 ports from a first “4 servers” in a first server rack (e.g., 615A) and (ii) 4 ports from a second “4 servers” in a second server rack (e.g., 615N) are considered to shuffle, where each rail pod has 6 server racks) that belong to the same “rail” leaf network switch and how the corresponding optical shuffler of the optical shufflers (620) perform the transformation/shuffling (discussed above in reference to FIG. 2.3) on these ports. As a result of the transformation, a set of 8 ports that needs to be connected to a related rail leaf network switch in each fabric plane (discussed above in reference to FIGS. 2.2-2.3) is obtained.

Referring to FIG. 6.1, in the rail pod (which includes 6 server racks, discussed above in reference to FIG. 2.1), each server rack (e.g., 615A) may host 36 servers (e.g., 616A, 616N, etc.). Further, a first set of leaf network switches (e.g., Network Switch (602A), Network Switch (610A), etc.) may indicate a first rail that is divided into 8 planes (e.g., Plane 1 (P1) of the first rail, Plane 2 (P2) of the first rail, etc.) and an eighth set of leaf network switches (e.g., Network Switch (602N), Network Switch (610N), etc.) may indicate an eighth rail that is divided into 8 planes (e.g., Plane 1 (P1) of the eighth rail, Plane 2 (P2) of the eighth rail, etc.). For example, as a result of the transformation (or after the shuffling), a first port (an OSFP connector that includes a first set of links) may be connected to the “first rail” leaf network switch on Plane 1, a second port may be connected to the “first rail” leaf network switch on Plane 2, etc. In this use case, 54 out of 64 OSFP connectors may be used on leaf network switches.

Thereafter, the resulting scalable unit may (i) include 6 server racks (e.g., 615A, 615N, etc.) and each server rack may include 144 GPUs (36 servers×4 GPUs), (ii) include 4 (or 2) network server racks (not shown) in between 4 server racks (on the left side of the scalable unit) and 2 server racks (on the rights side of the scalable unit), each including two fabric planes with 4 network switches per plane. As a result, each scalable unit (in this use case) may require 108 optical shufflers (620) (36 (per rack pair)×3 (rack pairs)).

In addition, when the aforementioned scalable unit is used to build a two-tier scale-out fabric (discussed above in reference to FIG. 2.1), the fabric (or the rail optimized scale-out fabric/network) may support up to 110,592 GPUs (144 GPUs per rack).

Referring to FIG. 6.2, network switches (e.g., 602A, 603A, 604A, 604N, etc.) may have the same or substantially the same functionality as the liked named components in FIG. 2.1. In order to perform the “leaf network switch to spine network switch” connectivity in the aforementioned fabric, each fabric plane may require the shuffler transformation discussed above in reference to FIG. 2.4. In this use case, the transformation may need to be applied to a pair of rail pods. Each of the 8 “rail” leaf network switches (in a rail pod pair) may have 27 uplinks. The shuffling (performed by one or more of the optical shufflers (622)) occurs among 8 ports that belong to the 8 “rail” leaf network switches, resulting in 216 ports to connect to 216 spine network switches. In view of this, each rail pod may require 27 optical shufflers per fabric plane (216 optical shufflers in total).

As indicated above, in order to solve the aforementioned multi-plane problem, the optical shuffler and the transformations (that can be performed by the shuffler) discussed above in reference to FIGS. 2.3-2.4 can be used. For example, in order to connect the NICs (of servers) to the leaf network switches (see FIG. 6.1) in a scalable unit, 108 optical shufflers may be needed. Separately, in order to connect the leaf network switches (of a scalable unit) to the spine network switches, 108 optical shufflers may be needed. Thus, in order to build a two-tier scale-out fabric (discussed above in reference to FIG. 2.1), 27,648 (128×108×2) optical shufflers and 5824 (728×8; 8 planes, each with 728 network switches) network switches may be needed.

In one or more embodiments, if the desired number of GPUs is 27,000 or less (indicating a smaller network fabric), then no fabric plane shuffling is needed, because connections using groups of 4 links/lanes (from leaf network switches to spine network switches) can be supported by regular optical cables.

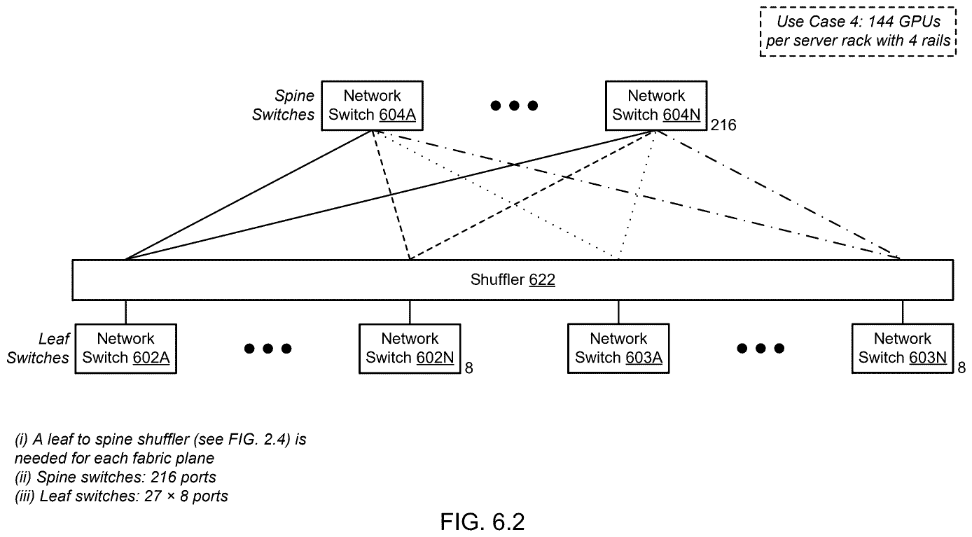

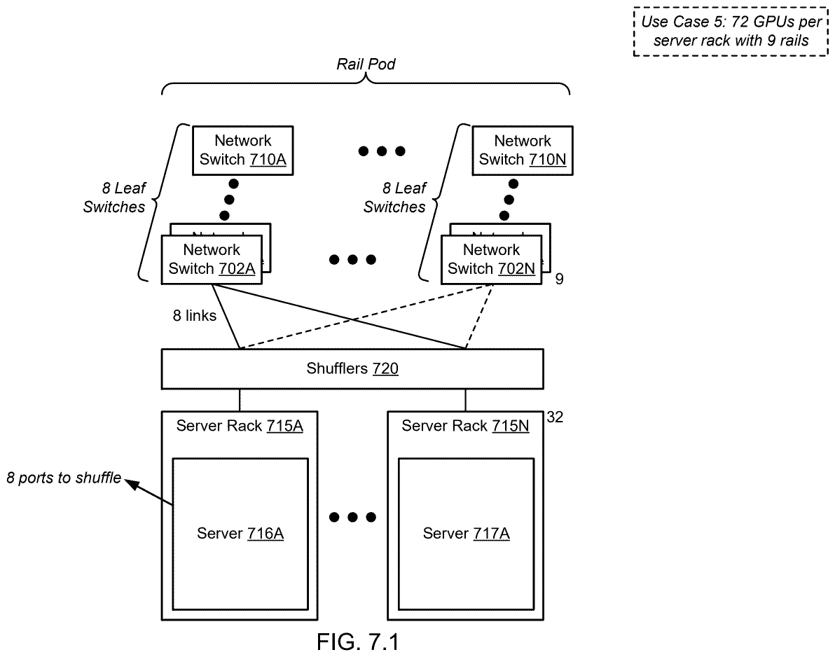

Turning now to FIGS. 7.1-7.2, FIGS. 7.1-7.2 show an example use case in accordance with one or more embodiments disclosed herein. The example use case (72 GPUs per server rack with 9 rails (or 9 rail leaf network switches), illustrated in FIGS. 7.1-7.2 and described below, is for explanatory purposes only and not intended to limit the scope of embodiments disclosed herein.

Referring to FIG. 7.1, server racks (e.g., 715A, 715N, etc.), servers (e.g., 716A, 717A, etc.), and network switches (e.g., 702A, 710A, 702N, 710N, etc.) may have the same or substantially the same functionality as the liked named components in FIGS. 1.2 and 2.1. FIG. 7.1 shows how to select 8 NIC ports (8 ports (from a related server) are considered to shuffle, where each rail pod has 32 server racks and each rack has a single server (that includes 72 GPUs and 72 NICs)) that belong to the same “rail” leaf network switch and how the corresponding optical shuffler of the optical shufflers (720) perform the transformation/shuffling (discussed above in reference to FIG. 2.3) on these ports. As a result of the transformation, a set of 8 ports that needs to be connected to a related rail leaf network switch in each fabric plane (discussed above in reference to FIGS. 2.2-2.3) is obtained.

Referring to FIG. 7.1, in the rail pod (which includes 32 server racks, discussed above in reference to FIG. 2.1), each server rack (e.g., 715A) may host a single server (e.g., 716A). Further, a first set of leaf network switches (e.g., Network Switch (702A), Network Switch (710A), etc.) may indicate a first rail that is divided into 8 planes (e.g., Plane 1 (P1) of the first rail, Plane 2 (P2) of the first rail, etc.) and an eighth set of leaf network switches (e.g., Network Switch (702N), Network Switch (710N), etc.) may indicate an eighth rail that is divided into 8 planes (e.g., Plane 1 (P1) of the eighth rail, Plane 2 (P2) of the eighth rail, etc.). For example, as a result of the transformation (or after the shuffling), a first port (an OSFP connector that includes a first set of links) may be connected to the “first rail” leaf network switch on Plane 1, a second port may be connected to the “first rail” leaf network switch on Plane 2, etc.

Thereafter, the resulting scalable unit may (i) include 32 server racks (e.g., 715A, 715N, etc.) and each server rack may include 72 GPUs (1 server×72 GPUs), (ii) include 4 network server racks (not shown) in between 16 server racks (on the left side of the scalable unit) and 16 server racks (on the rights side of the scalable unit), each including two fabric planes with 9 network switches per plane. As a result, each scalable unit (in this use case) may require 288 optical shufflers (720) (9 (per rack)×32 (racks)).

In addition, when the aforementioned scalable unit is used to build a two-tier scale-out fabric (discussed above in reference to FIG. 2.1), the fabric (or the rail optimized scale-out fabric) may support up to 129,024 GPUs (72 GPUs per rack).

Referring to FIG. 7.2, network switches (e.g., 702A, 703A, 704A, 704N, etc.) may have the same or substantially the same functionality as the liked named components in FIG. 2.1. In order to perform the “leaf network switch to spine network switch” connectivity in the aforementioned fabric, each fabric plane may require the shuffler transformation discussed above in reference to FIG. 2.4. In this use case, the transformation includes 9 rails (different from the other use cases above), while the shuffling (performed by one or more of the optical shufflers (722)) needs to happen in groups of 8 ports. To overcome this issue (referring to FIG. 7.2), the fabric is organized not as 56 pods/groups of 9 network switches, but instead as 9 groups of 56 switches. Each of these groups of 56 network switches can be subdivided into 7 sets of 8 network switches each. Further, each of the “rail” leaf network switches (in these sets) may have 32 uplinks, resulting in 256 ports to be shuffled (by 32 optical shufflers of the optical shufflers (722)). In view of this, (i) 256 ports needs to be connected to 256 spine network switches, (ii) 63 connectors needs to be used on the spine network switches, and (iii) 2016 (63×32) optical shufflers need to be used per fabric plane.

As indicated above, in order to solve the aforementioned multi-plane problem, the optical shuffler and the transformations (that can be performed by the shuffler) discussed above in reference to FIGS. 2.3-2.4 can be used. For example, in order to connect the NICs (of servers) to the leaf network switches (see FIG. 7.1) in a scalable unit, 288 optical shufflers may be needed. Separately, in order to connect the leaf network switches (of a scalable unit) to the spine network switches, 2016 optical shufflers may be needed. Thus, in order to build a two-tier scale-out fabric (discussed above in reference to FIG. 2.1), 32,256 ((56×288)+(2016×8)) optical shufflers and 5824 (728×8; 8 planes, each with 728 network switches) network switches may be needed.

In one or more embodiments, if the desired number of GPUs is 31,500 or less (indicating a smaller network fabric), then no fabric plane shuffling is needed, because connections using groups of 4 links/lanes (from leaf network switches to spine network switches) can be supported by regular optical cables.

As indicated in the aforementioned uses cases, the scale-out network interfaces (i.e. OSPF connectors) used by any GPU cluster (using a rail optimized topology for the scale-out fabric/network) can be arranged in groups of 8 interfaces that can be shuffled (by the optical shuffler (see FIGS. 2.3-2.4)) in order to, at least: (i) split the fabric planes (see e.g., FIG. 3.2) between NICs and leaf network switches and (ii) mix/shuffle the links/lanes between leaf network switches and spine network switches within a related fabric plane (see e.g., FIG. 3.3).

Turning now to FIG. 8, FIG. 8 shows a diagram of a computing device in accordance with one or more embodiments disclosed herein.

In one or more embodiments disclosed herein, the computing device (800) may include one or more computer processors (802), non-persistent storage (804) (e.g., volatile memory, such as RAM, cache memory), persistent storage (806) (e.g., a non-transitory computer readable medium, a hard disk, an optical drive such as a CD drive or a DVD drive, a Flash memory, etc.), a communication interface (812) (e.g., Bluetooth interface, infrared interface, network interface, optical interface, etc.), an input device(s) (810), an output device(s) (808), and numerous other elements (not shown) and functionalities. Each of these components is described below.

In one or more embodiments, the computer processor(s) (802) may be an integrated circuit for processing instructions. For example, the computer processor(s) (802) may be one or more cores or micro-cores of a processor. The computing device (800) may also include one or more input devices (810), such as a touchscreen, keyboard, mouse, microphone, touchpad, electronic pen, or any other type of input device. Further, the communication interface (812) may include an integrated circuit for connecting the computing device (800) to a network (e.g., a LAN, a WAN, Internet, mobile network, etc.) and/or to another device, such as another computing device.

In one or more embodiments, the computing device (800) may include one or more output devices (808), such as a screen (e.g., a liquid crystal display (LCD), plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (802), non-persistent storage (804), and persistent storage (806). Many different types of computing devices exist, and the aforementioned input and output device(s) may take other forms.

The problems discussed throughout this application should be understood as being examples of problems solved by embodiments described herein, and the various embodiments should not be limited to solving the same/similar problems. The disclosed embodiments are broadly applicable to address a range of problems beyond those discussed herein.

One or more embodiments disclosed herein may be implemented using instructions executed by one or more processors of a computing device. Further, such instructions may correspond to computer readable instructions that are stored on one or more non-transitory computer readable mediums.

While embodiments discussed herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A system, the system comprising:
a set of server racks,
wherein a client is operatively connected to a server rack of the set of server racks over a network;
the network,
wherein the network is structured as a set of disjoint parallel planes (DPPs) to support an operation mode of a first network interface card (NIC),
wherein each plane of the set of DPPs comprises a set of leaf switches (LSs) and a set of spine switches (SSs); and
a first shuffler and a second shuffler;
wherein the server rack comprises a first server and a second server,
wherein the first server comprises the first NIC and the second server comprises a second NIC,
wherein the first NIC comprises an octal small form factor pluggable (OSFP) cage that hosts an OSFP module comprising a set of ports,
wherein the set of ports is exposed to the network as a set of links,
wherein each of the set of ports belongs to a different plane of the set of DPPs,
wherein the first shuffler shuffles the set of links and a second set of links of the second NIC to obtain:
a third set of links that belongs to a first plane of the set of DPPs, and
a fourth set of links that belongs to a second plane of the set of DPPs,
wherein, after the shuffling, the first shuffler operatively connects:
the third set of links to a first LS of the first plane,
the fourth set of links to a second LS of the second plane,
wherein the second shuffler shuffles the third set of links and a fifth set of links to obtain:
a sixth set of links that is operatively connected to a first SS of the first plane, and
a seventh set of links that is operatively connected to a second SS of the first plane, wherein the first SS and the second SS manages a communication between a first processing unit (PU) of the first server and a second PU of the second server.

2. The system of claim 1, wherein the first LS is a network switch.

3. The system of claim 1, wherein the first SS is a network switch.

4. The system of claim 1, wherein the server rack is a housing for the first server and the second server.

5. The system of claim 1, wherein the first PU is a graphics processing unit (GPU), a neural processing unit (NPU), a tensor processing unit (TPU), or a central processing unit (CPU).

6. The system of claim 5, wherein the first PU and the first NIC are operatively connected to each other over a peripheral component interconnect express (PCIe).

7. The system of claim 1, wherein the fifth set of links belongs to a third plane of the set of DPPs.

8. The system of claim 1,
wherein the second shuffler is only for the first plane, and
wherein the second shuffler is located in between the first SS and the first LS.

9. The system of claim 1,
wherein the first NIC operates in at least three operation modes, and
wherein, based on the operation mode of the three operation modes, the first PU infers that the first server has a third NIC in addition to the first NIC.

10. The system of claim 1, wherein the first shuffler is an optical shuffler to be used in a rail optimized scale-out network.

11. The system of claim 1,
wherein the network is a scale-out network, and
wherein the scale-out network is a rail optimized scale-out network.

12. The system of claim 1, wherein each of the set of ports supports a 100 gigabits per second data transfer rate network protocol.

13. The system of claim 1, wherein the first shuffler is located in the server rack.

14. A server rack, the server rack comprising:
a first server,
wherein the first server comprises a first network interface card (NIC) and a first processing unit (PU),
wherein the first NIC comprises an octal small form factor pluggable (OSFP) cage that hosts an OSFP module comprising a set of ports,
wherein the set of ports is exposed to a rail optimized scale-out network as a set of links,
wherein each of the set of ports belongs to a different plane of a set of disjoint parallel planes (DPPs),
wherein the network is structured as the set of DPPs to support an operation mode of the first NIC,
wherein each plane of the set of DPPs comprises a set of leaf switches (LSs) and a set of spine switches (SSs); and
a second server, wherein the second server comprises a second NIC and a second PU,
wherein a first optical shuffler shuffles the set of links and a second set of links of the second NIC to obtain:
a third set of links that belongs to a first plane of the set of DPPs, and
a fourth set of links that belongs to a second plane of the set of DPPs,
wherein, after the shuffling, the first optical shuffler operatively connects:
the third set of links to a first LS of the first plane,
the fourth set of links to a second LS of the second plane,
wherein a second optical shuffler shuffles the third set of links and a fifth set of links to obtain:
a sixth set of links that is operatively connected to a first SS of the first plane, and
a seventh set of links that is operatively connected to a second SS of the first plane, wherein first SS and the second SS manages a communication between the first PU and the second PU.

15. The server rack of claim 14, wherein the first LS is a network switch.

16. The server rack of claim 14, wherein the first SS is a network switch.

17. The server rack of claim 14, wherein the first PU is a graphics processing unit (GPU), a neural processing unit (NPU), a tensor processing unit (TPU), or a central processing unit (CPU).

18. The server rack of claim 14,
wherein the second optical shuffler is only for the first plane, and
wherein the second optical shuffler is located in between the first SS and the first LS.

19. The server rack of claim 14,
wherein the first NIC operates in at least three operation modes, and
wherein, based on the operation mode of the three operation modes, the first PU infers that the first server has a third NIC in addition to the first NIC.

20. The server rack of claim 14, wherein the first optical shuffler is located in the server rack.
